(19) United States
(12) Patent Application Publication
(10) Pub. No.: US 2023/0294069 A1
(43) Pub. Date: Sep. 21, 2023

(54) SINGLE-WALLED ZEOLITIC NANOTUBES IMPREGNATED WITH AN AMINE AND METHODS OF MAKING AND USE THEREOF

(71) Applicant: Georgia Tech Research Corporation, Atlanta, GA (US)

(72) Inventors: Christopher W. Jones, Atlanta, GA (US); Enerelt Burentugs, Atlanta, GA (US); Akshay Korde, Atlanta, GA (US); Sankar Nair, Atlanta, GA (US); Iman Nezam, Atlanta, GA (US); Gabriel Nicholas Short, Atlanta, GA (US)

(21) Appl. No.: 18/120,583

(22) Filed: Mar. 13, 2023

Related U.S. Application Data
(60) Provisional application No. 63/319,960, filed on Mar. 15, 2022.

(51) Int. Cl. B01J 20/18; B01J 20/28; B01J 20/32; B01D 53/02

(52) U.S. Cl. CPC B01J 20/183; B01J 20/28007; B01J 20/2808; B01J 20/3204; B01J 20/3272; B01D 53/02; B01D 2253/25; B01D 2253/308; B01D 2253/304; B01D 2257/504

(57) ABSTRACT

Disclosed herein are impregnated nanostructured hierarchical zeolitic materials comprising: a plurality of zeolite nanotubes, wherein each zeolite nanotube comprises a zeolitic wall perforated by a plurality of pores, the zeolitic wall defining a single longitudinal lumen, and wherein at least a portion of the plurality of zeolite nanotubes are impregnated with an amine.

### CROSS-REFERENCE TO RELATED APPLICATIONS

This application claims the benefit of priority to U.S. Provisional Application No. 63/319,960 filed Mar. 15, 2022, which is hereby incorporated herein by reference in its entirety.

### STATEMENT OF GOVERNMENT SUPPORT

This invention was made with government support under Grant No. GR10006509 awarded by The National Science Foundation. The government has certain rights in the invention.

### BACKGROUND

Zeolites have been widely used as size- and shape-selective catalysts and adsorbents, because of their ordered microporous structure. In recent years, there has been large interest in the synthesis of hierarchical zeolites. However, the synthesis of such hierarchical zeolites has proved challenging. Further, improved methods of chemical separations and/or materials therefore are needed. For example, increasing levels of CO₂ necessitate improved methods of capturing this greenhouse gas to limit rising global temperatures. The compositions and methods discussed herein address these and other needs.

### SUMMARY

In accordance with the purposes of the disclosed compositions and methods as embodied and broadly described herein, the disclosed subject matter relates to zeolite nanotubes and methods of making and use thereof, specifically, utilizing zeolite nanotubes as a substrate impregnated with an amine, such as PEI, for CO₂ capture, H₂S capture, or a combination thereof.

For example, disclosed herein are impregnated nanostructured hierarchical zeolitic materials comprising: a plurality of zeolite nanotubes, wherein each zeolite nanotube comprises a zeolitic wall perforated by a plurality of pores, the zeolitic wall defining a single longitudinal lumen, and wherein at least a portion of the plurality of zeolite nanotubes are impregnated with an amine.

In some examples, the amine comprises a primary amine, a secondary amine, a tertiary amine, or a combination thereof.

In some examples, the amine comprises a small molecule such as monoethanolamine (MEA), diethanolamine (DEA), an amino acid (e.g., lysine, glutamic acid), or a combination thereof.

In some examples, the amine comprises an aliphatic-aryl amine. In some examples, the amine can comprise an aliphatic-aryl amine of Formula I:

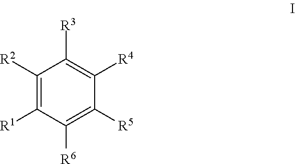

wherein R¹, R², R³, R⁴, R⁵, and R⁶ are each independently H or an aliphatic amine (e.g., a substituted or unsubstituted C₁-C₂₀ aliphatic amine).

In some examples, R¹-R⁶ are each independently a substituted or unsubstituted C₁-C₂₀ aliphatic amine. In some examples, R¹-R⁶ are the same.

In some examples, R², R⁴, and R⁶ are each hydrogen. In some examples, R¹, R³, and R⁵ are each a substituted or unsubstituted C₁-C₂₀ aliphatic amine. In some examples, R¹, R³, and R⁵ are the same.

In some examples, the amine is sterically hindered. In some examples, the amine comprises tert-butylaminopropyltrimethoxysilane (TBAPS), (N,N-dimethylaminopropyl)trimethoxysilane (DMAPS), (N-cyclohexylaminopropyl)trimethoxysilane (CHAPS), (3-amino-3-methylbutyl)trimethoxysilane (AMBS), derivatives thereof, and combinations thereof.

In some examples, the amine comprises an aminopolymer. In some examples, the aminopolymer is branched, linear, or a combination thereof. In some examples, the amine comprises poly(allylamine) (PAA), poly(glycidyl amine) (PGA), poly(propyleneimine) (PPI), poly(ethyleneimine) (PEI), derivatives thereof, or combinations thereof.

In some examples, the amine comprises poly(ethyleneimine). In some examples, the amine comprises branched poly(ethyleneimine), linear poly(ethyleneimine), or a combination thereof. In some examples, the amine comprises branched poly(ethyleneimine).

In some examples, the material comprises the amine in an amount of from greater than 0 to 120 w/w %. In some examples, the material comprises the amine in an amount of from greater than 0 to 100 w/w %. In some examples, the material comprises the amine in an amount of from 20 w/w % to 80 w/w %, from 50 to 80 w/w %, from 60 to 80 w/w %, from 50 to 70 w/w %, or from 60 to 70 w/w %.

In some examples, the zeolitic wall comprises a zeolitic material, the zeolitic material comprising an aluminosilicate material. The aluminosilicate material can, for example, comprise Si and Al in a ratio of from 14:1 to 18:1 (w/w). In some examples, the zeolitic wall comprises some structural elements of a beta zeolite structure, an MFI zeolite structure, or a combination thereof.

In some examples, the plurality of zeolite nanotubes have an average length of from 20 nanometers (nm) to 10 micrometers (μm, microns). In some examples, the plurality of zeolite nanotubes have an average length of from 500 nm to 1 micron.

In some examples, the plurality of zeolite nanotubes have an average outer diameter of from 1 nanometer to 10 nanometers. In some examples, the plurality of zeolite nanotubes have an average outer diameter of from 4 nm to 6 nm.

In some examples, the plurality of zeolite nanotubes have an average aspect ratio of from 2 to 10,000. In some examples, the plurality of zeolite nanotubes have an average aspect ratio of from 100 to 200.

In some examples, the plurality of zeolite nanotubes have an average inner diameter of 0.5 nm to 9 nm. In some examples, the plurality of zeolite nanotubes have an average inner diameter of from 2 nm to 4 nm.

In some examples, the plurality of zeolite nanotubes have an average wall thickness of from 0.5 nm to 5 nm. In some examples, the plurality of zeolite nanotubes have an average wall thickness of from 0.5 nm to 2 nm.

In some examples, the plurality of pores have an average diameter of from 0.2 to 2 nm.

In some examples, the plurality of pores have an average diameter of from 0.4 to 0.6 nm.

In some examples, the plurality of zeolite nanotubes are substantially crystalline.

In some examples, the plurality of zeolite nanotubes have an average surface area of from 500 to 5000 meters squared per gram of the plurality of zeolite nanotubes (m²/g). In some examples, the plurality of zeolite nanotubes have an average surface area of from 950 to 1000 m²/g.

In some examples, the plurality of zeolite nanotubes further comprise a structure directing agent. In some examples, the structure directing agent comprises a bolaform structure directing agent.

In some examples, the bolaform structure directing agent comprises a first hydrophilic end and a second hydrophilic end with a hydrophobic core therebetween. In some examples, the hydrophobic core comprises one or more aromatic rings, one or more hydrophobic alkyl groups, or a combination thereof. In some examples, the hydrophobic core comprises one or more aromatic rings, and the one or more aromatic rings comprises a substituted or unsubstituted biphenyl group, a substituted or unsubstituted naphthalene group, a substituted or unsubstituted anthracene group, a substituted or unsubstituted pyrene group, or a combination thereof. In some examples, the hydrophobic core comprises one or more aromatic rings, and the one or more aromatic rings comprises a substituted or unsubstituted biphenyl group. In some examples, the hydrophobic core comprise one or more hydrophobic alkyl groups, and the one or more hydrophobic alkyl groups each independently comprises a substituted or unsubstituted C₁-C₂₀ alkyl group. In some examples, the hydrophobic core comprise one or more hydrophobic alkyl groups, and the one or more hydrophobic alkyl groups each independently comprises a substituted or unsubstituted C₁₀ alkyl group. In some examples, the first hydrophilic end and the second hydrophilic end each independently comprises a hydrophilic group. In some examples, the first hydrophilic end and the second hydrophilic end each independently comprises a quinuclidinium group. In some examples, the structure directing agent comprises a molecule with the following structure.

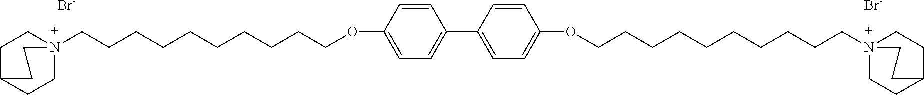

Also disclosed herein are methods of making the materials disclosed herein.

Also disclosed herein are methods of use of the materials disclosed herein. For example, the methods can comprise using the material as an adsorbent, in a chemical separation, or a combination thereof. In some examples, the method comprises using the material as a CO₂ adsorbent, in a CO₂ separation, or a combination thereof. In some examples, the method comprises using the material as a H₂S adsorbent, in a H₂S separation, or a combination thereof.

In some examples, the method includes using the material for CO₂ capture and/or storage. In some examples, the material captures 1.8 mmol CO₂ per gram of material or more, 2 mmol CO₂/gram or more, or 2.2 mmol CO₂/gram or more. In some examples, the material captures CO₂ at a rate of 2 mmol CO₂ per gram of material per minute or more, 4 mmol CO₂g⁻¹ₘₐₜₑᵣᵢₐₗmin⁻¹ or more, or 6 mmol CO₂g⁻¹ₘₐₜₑᵣᵢₐₗmin⁻¹ or more.

In some examples, the method includes using the material for H₂S capture and/or storage. Also disclosed herein are filters for separating a component from a fluid stream, the filter comprising any of the materials described herein.

Also disclosed herein are methods of using the above-described filters for separating a component from a fluid stream.

In some examples, the component separated from the fluid stream comprises CO₂. In some examples, the material captures 1.8 mmol CO₂ per gram of material or more, 2 mmol CO₂/gram or more, or 2.2 mmol CO₂/gram or more. In some examples, the material captures CO₂ at a rate of 2 mmol CO₂ per gram of material per minute or more, 4 mmol CO₂g⁻¹ₘₐₜₑᵣᵢₐₗmin⁻¹ or more, or 6 mmol CO₂g⁻¹ₘₐₜₑᵣᵢₐₗmin⁻¹ or more.

In some examples, the component separated from the fluid stream comprises H₂S.

In some examples, the fluid stream is selected from the group consisting of air, natural gas, byproducts of a chemical reaction, and post-combustion flue gas. In some examples, the fluid stream comprises air.

In some examples, the method comprises direct air capture.

In some examples, a single walled zeolite nanotube is disclosed for use in CO₂ capture. The zeolite nanotube can be used as a support for various amines, including poly(ethylenimine), as it is a highly ordered and highly porous material. A sorbent synthesized from the zeolite nanotube and an amines can be used to capture CO₂ from dilutes feeds. The amines chosen for the zeolite nanotube can be primarily poly(ethylenimine) and loaded into the zeolite nanotube at different weight percentages to find an optimum loading. A study was conducted that compared this sorbent against sorbents made from well-studied substrates SBA-15 and MCM-41 with large and small mesopore sizes but without regular micropores within the mesopore walls. The study tested the best performing zeolite nanotube sorbent for retained CO₂ capture efficiency at both 10% and 400 ppm CO₂ over multiple cycles. The study conducted the tests at different temperatures and in different levels of humidity on the zeolite nanotube sorbent. The study shows very fast uptake times of the example method, device, and composition to capture CO₂ when compared with other highly used substrates as well as higher CO₂ capacities. The sorbent works equally as well capturing CO₂ from dilute and ultra dilute CO₂ feeds.

The example method, device, and composition can be employed for CO₂ capture system and applications. The sorbent has shown useful at capturing CO₂ at flue gas levels (e.g., at around 10%) and at ambient ultra-dilute levels (e.g., 400 ppm). The example method, device, and composition could thus be used in the direct air capture of CO₂ or possible to capture CO₂ from higher concentrated sources.

Additional advantages of the disclosed compositions and methods will be set forth in part in the description which follows, and in part will be obvious from the description. The advantages of the disclosed compositions and methods will be realized and attained by means of the elements and combinations particularly pointed out in the appended claims. It is to be understood that both the foregoing general description and the following detailed description are exemplary and explanatory only and are not restrictive of the disclosed systems and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1. Zeolite nanotubes were deployed as a substrate for poly(ethylene imine) (PEI) for CO₂ capture. The CO₂ capture by the PEI-loaded zeolite nanotubes were compared with PEI-loaded mesoporous silica substrates.

FIG. 2. Comparison of CO₂ uptake at different pore fillings of poly(ethylenimine) on the four substrates.

FIG. 3. Amine efficiencies as function of weight fraction of poly(ethylenimine) in various composites.

FIG. 4. CO₂ uptake kinetics of poly(ethylenimine) (PEI) loaded zeolite nanotubes (ZN), SBA-15, MCM-41-2.9, and MCM-41-5.8 with a flow of 10% CO₂/He at 30° C., with each sorbent having the poly(ethylenimine) loading that gives maximum CO₂ uptake.

FIG. 5. Comparison for the rate of CO₂ uptake kinetics from 0-1.5 minutes of poly(ethylenimine) (PEI) loaded zeolite nanotubes (ZN), SBA-15, MCM-41-2.9, and MCM-41-5.8 with a flow of 10% CO₂/He at 30° C., with each sorbent having the poly(ethylenimine) loading that gives maximum CO₂ uptake.

FIG. 6. STEM image of bare zeolite nanotubes studied for CO₂ capture.

FIG. 7. SEM image of bare zeolite nanotubes studied for CO₂ capture.

FIG. 8. STEM image of zeolite nanotube composite (ZN-65% PEI) studied for CO₂ capture.

FIG. 9. SEM image of zeolite nanotube composite (ZN-65% PEI) studied for CO₂ capture.

FIG. 10. STEM image of bare silica-based support MCM-41-5.8.

FIG. 11. SEM image of bare silica-based support MCM-41-5.8.

FIG. 12. STEM image of bare silica-based support MCM-41-2.9.

FIG. 13. SEM image of bare silica-based support MCM-41-2.9.

FIG. 14. STEM image of bare silica-based support SBA-15.

FIG. 15. SEM image of bare silica-based support SBA-15.

FIG. 16. STEM image of MCM-41-5.8 composite used for CO₂ capture.

FIG. 17. SEM image of MCM-41-5.8 composite used for CO₂ capture.

FIG. 18. STEM image of MCM-41-2.9 composite used for CO₂ capture.

FIG. 19. SEM image of MCM-41-2.9 composite used for CO₂ capture.

FIG. 20. STEM image of SBA-15 composite used for CO₂ capture.

FIG. 21. SEM image of SBA-15 composite used for CO₂ capture.

FIG. 22. Average length of support particles to the longest direction. This direction represents the mesopore length.

FIG. 23. CO₂ sorption dynamics comparison between poly(ethylenimine) loaded zeolite nanotubes with flow of 10% CO₂/He and 400 ppm CO₂ at 30° C.

FIG. 24. CO₂ sorption dynamics from 0-1.5 minutes comparison between poly(ethylenimine) loaded zeolite nanotubes with flow of 10% CO₂/He and 400 ppm CO₂ at 30° C.

FIG. 25. Normalized CO₂ sorption cycles using 10% CO₂ for zeolite nanotubes loaded with 65 wt. % poly(ethylenimine).

FIG. 26. Normalized CO₂ sorption cycles using 400 ppm CO₂ for zeolite nanotubes loaded with 65 wt. % poly(ethylenimine).

FIG. 27. CO₂ uptake (400 ppm CO₂) under humid conditions from 0-37.4% relative humidity at 30° C. in a gravimetric system equipped with CO₂ stream with varied humidity.

FIG. 28. Humid CO₂ uptake results under varied relative humidity at 30° C. and 400 ppm CO₂.

FIG. 29. Humid uptake results showing both H₂O and CO₂ contributions. The first mass increase (marked with H₂O in blue) is due to water adsorption (during pre-saturation steps). The second increase is from feeding wet CO₂ to the samples at constant water activity. CO₂ uptake capacities are calculated based on: mass gained after CO₂ input→mmol CO₂ calculated→mmol CO₂ divided with mass of dry sorbent (before water adsorption).

FIG. 30. SEM image of the zeolite nanotubes.

FIG. 31. SEM image for large pore size MCM-41 (obtained after being gold coated).

FIG. 32. SEM image for SBA-15 (obtained after being gold coated).

FIG. 33. SEM image for small pore MCM-41 (obtained after being gold coated).

FIG. 34. Temperature swing cycles at 400 ppm of ZN 65% PEI from 0° C. to 30° C.

### DETAILED DESCRIPTION

The compositions, methods, and systems described herein may be understood more readily by reference to the following detailed description of specific aspects of the disclosed subject matter and the Examples included therein.

Before the present compositions, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings.

Throughout the description and claims of this specification, the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Values can be expressed herein as an “average” value. “Average” generally refers to the statistical mean value.

By “substantially” is meant within 5%, e.g., within 4%, 3%, 2%, or 1%.

“Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Chemical Definitions Unless otherwise defined, all technical and scientific terms used herein have the same meaning as commonly understood by one of ordinary skill in the art to which this invention belongs.

The organic moieties mentioned when defining variable positions within the general formulae described herein (e.g., the term “halogen”) are collective terms for the individual substituents encompassed by the organic moiety. The prefix Cₙ-Cₘ preceding a group or moiety indicates, in each case, the possible number of carbon atoms in the group or moiety that follows.

The term “ion,” as used herein, refers to any molecule, portion of a molecule, cluster of molecules, molecular complex, moiety, or atom that contains a charge (positive, negative, or both at the same time within one molecule, cluster of molecules, molecular complex, or moiety (e.g., zwitterions)) or that can be made to contain a charge. Methods for producing a charge in a molecule, portion of a molecule, cluster of molecules, molecular complex, moiety, or atom are disclosed herein and can be accomplished by methods known in the art, e.g., protonation, deprotonation, oxidation, reduction, alkylation, acetylation, esterification, de-esterification, hydrolysis, etc.

The term “anion” is a type of ion and is included within the meaning of the term “ion.” An “anion” is any molecule, portion of a molecule (e.g., zwitterion), cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., zwitterion), cluster of molecules, molecular complex, moiety, or atom, that contains a net positive charge or that can be made to contain a net positive charge. The term “cation precursor” is used herein to specifically refer to a molecule that can be converted to a cation via a chemical reaction (e.g., protonation or alkylation).

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

“Z¹,” “Z²,” “Z³,” and “Z⁴” are used herein as generic symbols to represent various specific substituents. These symbols can be any substituent, not limited to those disclosed herein, and when they are defined to be certain substituents in one instance, they can, in another instance, be defined as some other substituents.

The term “aliphatic” as used herein refers to a non-aromatic hydrocarbon group and includes branched and unbranched, alkyl, alkenyl, or alkynyl groups.

As used herein, the term “alkyl” refers to saturated, straight-chained or branched saturated hydrocarbon moieties. Unless otherwise specified, C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl groups are intended. Examples of alkyl groups include methyl, ethyl, propyl, 1-methyl-ethyl, butyl, 1-methyl-propyl, 2-methyl-propyl, 1,1-dimethyl-ethyl, pentyl, 1-methyl-butyl, 2-methyl-butyl, 3-methyl-butyl, 2,2-dimethyl-propyl, 1-ethyl-propyl, hexyl, 1,1-dimethyl-propyl, 1,2-dimethyl-propyl, 1-methyl-pentyl, 2-methyl-pentyl, 3-methyl-pentyl, 4-methyl-pentyl, 1,1-dimethyl-butyl, 1,2-dimethyl-butyl, 1,3-dimethyl-butyl, 2,2-dimethyl-butyl, 2,3-dimethyl-butyl, 3,3-dimethyl-butyl, 1-ethyl-butyl, 2-ethyl-butyl, 1,1,2-trimethyl-propyl, 1,2,2-trimethyl-propyl, 1-ethyl-1-methyl-propyl, 1-ethyl-2-methyl-propyl, heptyl, octyl, nonyl, decyl, dodecyl, tetradecyl, hexadecyl, eicosyl, tetracosyl, and the like. Alkyl substituents may be unsubstituted or substituted with one or more chemical moieties. The alkyl group can be substituted with one or more groups including, but not limited to, hydroxyl, halogen, acyl, alkyl, alkoxy, alkenyl, alkynyl, aryl, heteroaryl, aldehyde, amino, cyano, carboxylic acid, ester, ether, ketone, nitro, phosphonyl, silyl, sulfo-oxo, sulfonyl, sulfone, sulfoxide, or thiol, as described below, provided that the substituents are sterically compatible and the rules of chemical bonding and strain energy are satisfied.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halides (halogens; e.g., fluorine, chlorine, bromine, or iodine). The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

As used herein, the term “alkenyl” refers to unsaturated, straight-chained, or branched hydrocarbon moieties containing a double bond. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, or C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure —CH═CH—CH₃; and 2-propenyl refers to a group with the structure —CH₂—CH═CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C. Alkenyl substituents may be unsubstituted or substituted with one or more chemical moieties. Examples of suitable substituents include, for example, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol, as described below, provided that the substituents are sterically compatible and the rules of chemical bonding and strain energy are satisfied.

As used herein, the term “alkynyl” represents straight-chained or branched hydrocarbon moieties containing a triple bond. Unless otherwise specified, C₂-C₂₄ (e.g., C₂-C₂₄, C₂-C₂₀, C₂-C₁₈, C₂-C₁₆, C₂-C₁₄, C₂-C₁₂, C₂-C₁₀, C₂-C₈, C₂-C₆, or C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl. Alkynyl substituents may be unsubstituted or substituted with one or more chemical moieties. Examples of suitable substituents include, for example, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol, as described below.

As used herein, the term “aryl,” as well as derivative terms such as aryloxy, refers to groups that include a monovalent aromatic carbocyclic group of from 3 to 50 carbon atoms. Aryl groups can include a single ring or multiple condensed rings. In some examples, aryl groups include C₆-C₁₀ aryl groups. Examples of aryl groups include, but are not limited to, benzene, phenyl, biphenyl, naphthyl, tetrahydronaphthyl, phenylcyclopropyl, phenoxybenzene, and indanyl. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. The term “non-heteroaryl,” which is also included in the term “aryl,” defines a group that contains an aromatic group that does not contain a heteroatom. The aryl substituents may be unsubstituted or substituted with one or more chemical moieties. Examples of suitable substituents include, for example, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol as described herein.

The term “cycloalkenyl” as used herein is a non-aromatic carbon-based ring composed of at least three carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The term “heterocycloalkenyl” is a type of cycloalkenyl group as defined above and is included within the meaning of the term “cycloalkenyl,” where at least one of the carbon atoms of the ring is substituted with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol as described herein.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems (e.g., monocyclic, bicyclic, tricyclic, polycyclic, etc.) that can be substituted or unsubstituted. A cyclic group can contain one or more aryl groups, one or more non-aryl groups, or one or more aryl groups and one or more non-aryl groups.

The term “acyl” as used herein is represented by the formula —C(O)Z¹ where Z¹ can be a hydrogen, hydroxyl, alkoxy, alkyl, alkenyl, alkynyl, aryl, heteroaryl, cycloalkyl, cycloalkenyl, heterocycloalkyl, or heterocycloalkenyl group described above. As used herein, the term “acyl” can be used interchangeably with “carbonyl.” Throughout this specification “C(O)” or “CO” is a shorthand notation for C═O.

The term “acetal” as used herein is represented by the formula (Z¹Z²)C(═OZ³)(═OZ⁴), where Z¹, Z², Z³, and Z⁴ can be, independently, a hydrogen, halogen, hydroxyl, alkyl, alkenyl, alkynyl, aryl, heteroaryl, cycloalkyl, cycloalkenyl, heterocycloalkyl, or heterocycloalkenyl group described above.

The term “alkanol” as used herein is represented by the formula Z¹OH, where Z¹ can be an alkyl, alkenyl, alkynyl, aryl, heteroaryl, cycloalkyl, cycloalkenyl, heterocycloalkyl, or heterocycloalkenyl group described above.

As used herein, the term “alkoxy” as used herein is an alkyl group bound through a single, terminal ether linkage; that is, an “alkoxy” group can be defined as to a group of the formula Z¹—O—, where Z¹ is unsubstituted or substituted alkyl as defined above. Unless otherwise specified, alkoxy groups wherein Z¹ is a C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-di-methyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-penoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl-1-methyl-propoxy, and 1-ethyl-2-methyl-propoxy.

The term “aldehyde” as used herein is represented by the formula —C(O)H. Throughout this specification “C(O)” is a shorthand notation for C═O.

The term “amino” as used herein are represented by the formula —NZ¹Z²Z³, where Z¹, Z², and Z³ can each be substitution group as described herein, such as hydrogen, an alkyl, alkenyl, alkynyl, aryl, heteroaryl, cycloalkyl, cycloalkenyl, heterocycloalkyl, or heterocycloalkenyl group described above.

The terms “amide” or “amido” as used herein are represented by the formula —C(O)NZ¹Z², where Z¹ and Z² can each be substitution group as described herein, such as hydrogen, an alkyl, alkenyl, alkynyl, aryl, heteroaryl, cycloalkyl, cycloalkenyl, heterocycloalkyl, or heterocycloalkenyl group described above.

The term “anhydride” as used herein is represented by the formula Z¹C(O)OC(O)Z² where Z¹ and Z², independently, can be an alkyl, alkenyl, alkynyl, aryl, heteroaryl, cycloalkyl, cycloalkenyl, heterocycloalkyl, or heterocycloalkenyl group described above.

The term “cyclic anhydride” as used herein is represented by the formula:

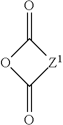

where Z¹ can be an alkyl, alkenyl, alkynyl, aryl, heteroaryl, cycloalkyl, cycloalkenyl, heterocycloalkyl, or heterocycloalkenyl group described above.

The term “azide” as used herein is represented by the formula —N═N═N.

The term “carboxylic acid” as used herein is represented by the formula —C(O)OH.

A “carboxylate” or “carboxyl” group as used herein is represented by the formula —C(O)O⁻.

The term “cyano” as used herein is represented by the formula —CN.

The term “ester” as used herein is represented by the formula —OC(O)Z¹ or —C(O)OZ¹, where Z¹ can be an alkyl, alkenyl, alkynyl, aryl, heteroaryl, cycloalkyl, cycloalkenyl, heterocycloalkyl, or heterocycloalkenyl group described above.

The term “ether” as used herein is represented by the formula Z¹OZ², where Z¹ and Z² can be, independently, an alkyl, alkenyl, alkynyl, aryl, heteroaryl, cycloalkyl, cycloalkenyl, heterocycloalkyl, or heterocycloalkenyl group described above.

The term “epoxy” or “epoxide” as used herein refers to a cyclic ether with a three atom ring and can represented by the formula:

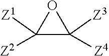

where Z¹, Z², Z³, and Z⁴ can be, independently, an alkyl, alkenyl, alkynyl, aryl, heteroaryl, cycloalkyl, cycloalkenyl, heterocycloalkyl, or heterocycloalkenyl group described above

The term “ketone” as used herein is represented by the formula Z¹C(O)Z², where Z¹ and Z² can be, independently, an alkyl, alkenyl, alkynyl, aryl, heteroaryl, cycloalkyl, cycloalkenyl, heterocycloalkyl, or heterocycloalkenyl group described above.

The term “halide” or “halogen” or “halo” as used herein refers to fluorine, chlorine, bromine, and iodine.

The term “hydroxyl” as used herein is represented by the formula —OH.

The term “nitro” as used herein is represented by the formula —NO₂.

The term “phosphonyl” is used herein to refer to the phospho-oxo group represented by the formula —P(O)(OZ¹)₂, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “silyl” as used herein is represented by the formula —SiZ¹Z²Z³, where Z¹, Z², and Z³ can be, independently, hydrogen, alkyl, alkoxy, alkenyl, alkynyl, aryl, heteroaryl, cycloalkyl, cycloalkenyl, heterocycloalkyl, or heterocycloalkenyl group described above.

The term “sulfonyl” or “sulfone” is used herein to refer to the sulfo-oxo group represented by the formula —S(O)₂Z¹, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “sulfide” as used herein is comprises the formula —S—.

The term “thiol” as used herein is represented by the formula —SH.

“R¹,” “R²,” “R³,” “Rⁿ,” etc., where n is some integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an amino group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

Unless stated to the contrary, a formula with chemical bonds shown only as solid lines and not as wedges or dashed lines contemplates each possible stereoisomer or mixture of stereoisomer (e.g., each enantiomer, each diastereomer, each meso compound, a racemic mixture, or scalemic mixture).

Nanostructured Zeolitic Materials

Disclosed herein are nanostructured zeolitic materials. As used herein, “nanostructured” means any structure with one or more nanoscale features. A nanoscale feature can be any feature with at least one dimension less than 1 micrometer (μm) in size (e.g., from 1 nm to less than 1 micrometer). For example, a nanoscale feature can comprise a nanowire, nanotube, nanoparticle, nanopore, and the like, or combinations thereof. As such, the nanostructured zeolitic materials can comprise, for example, a nanowire, nanotube, nanoparticle, nanopore, or a combination thereof comprising a zeolite. In some examples, the nanostructured zeolitic materials can comprise a zeolite that is not nanoscale but has been modified with a nanowire, nanotube, nanoparticle, nanopore, or a combination thereof.

In some examples, the nanostructured zeolitic materials comprise a plurality of zeolite nanotubes (e.g., a plurality of nanotubes comprising a zeolite material), wherein each nanotube comprises a zeolitic wall perforated by a plurality of pores, the zeolitic wall defining a single longitudinal lumen, such that the plurality of zeolite nanotubes are hollow. The zeolitic wall is circumferentially disposed about a central longitudinal axis and encloses a single central elongated void which is the lumen. The zeolitic wall can have an outer surface and an inner surface, wherein the inner surface defined the lumen.

In some examples, wherein the zeolitic wall comprises a zeolitic material, such as an aluminosilicate material, SAPO, ALPO, etc.

In some examples, the zeolitic wall can comprise an aluminosilicate material. In some examples, the aluminosilicate material can further comprise Ga, Ge, Ti, B, Be, Sn, Fe, Zr, or a combination thereof.

The aluminosilicate can comprise Si and Al in any desired ratio. In some examples, the aluminosilicate material comprises Si and Al in a ratio of from 99:1 to 1:99. In some examples, the aluminosilicate material comprises Si and Al in a ratio of 1:1 or more (e.g., 2:1 or more, 5:1 or more, 10:1 or more, 20:1 or more, or 50:1 or more). In some examples, the aluminosilicate material comprises Si and Al in a ratio of 14:1 (w/w) or more (e.g., 14.5:1 or more, 15:1 or more, 15.5:1 or more, 16:1 or more, 16.5:1 or more, 17:1 or more, or 17.5:1 or more). In some examples, the aluminosilicate material comprises Si and Al in a ratio of 18:1 (w/w) or less (e.g., 17.5:1 or less, 17:1 or less, 16.5:1 or less, 16:1 or less, 15.5:1 or less, 15:1 or less, or 14.5:1 or less). The ratio of Si and Al in the aluminosilicate material can range from any of the minimum values described above to any of the maximum values described above. For example, the aluminosilicate material can comprise Si and Ai in a ratio of from 14:1 to 18:1 (w/w) (e.g., from 14:1 to 16:1, from 16:1 to 18:1, from 14:1 to 15:1, from 15:1 to 16:1, from 16:1 to 17:1, from 17:1 to 18:1, from 15:1 to 18:1, from 14:1 to 17:1, or from 15:1 to 17:1).

In some examples, the zeolitic wall comprises some structural elements of a beta zeolite structure, an MFI zeolite structure, or a combination thereof.

In some examples, the plurality of zeolite nanotubes can be substantially crystalline.

The plurality of zeolite nanotubes can, for example, have an average length. “Average length” and “mean length” are used interchangeably herein, and generally refer to the statistical mean length of the nanotubes in a population of nanotubes. Mean length can be measured using methods known in the art, such as evaluation by scanning electron microscopy, transmission electron microscopy, and/or dynamic light scattering. As used herein, the average length is determined by transmission electron microscopy.

In some examples, the plurality of zeolite nanotubes have an average length of 20 nanometers (nm) or more (e.g., 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 275 nm or more, 300 nm or more, 325 nm or more, 350 nm or more, 400 nm or more, 450 nm or more, 500 nm or more, 600 nm or more, 700 nm or more, 800 nm or more, 900 nm or more, 1 micrometer (μm, micron) or more, 1.25 μm or more, 1.5 μm or more, 1.75 μm or more, 2 μm or more, 2.25 μm or more, 2.5 μm or more, 3 μm or more, 3.5 μm or more, 4 μm or more, 4.5 μm or more, 5 μm or more, 6 μm or more, 7 μm or more, 8 μm or more, or 9 μm or more). In some examples, the plurality of zeolite nanotubes can have an average length of 10 micrometers (μm, microns) or less (e.g., 9 μm or less, 8 μm or less, 7 μm or less, 6 μm or less, 5 μm or less, 4.5 μm or less, 4 μm or less, 3.5 μm or less, 3 μm or less, 2.5 μm or less, 2.25 μm or less, 2 μm or less, 1.75 μm or less, 1.5 μm or less, 1.25 μm or less, 1 μm or less, 900 nm or less, 800 nm or less, 700 nm or less, 600 nm or less, 500 nm or less, 450 nm or less, 400 nm or less, 350 nm or less, 325 nm or less, 300 nm or less, 275 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, or 25 nm or less). The average length of the plurality of zeolite nanotubes can range from any of the minimum values described above to any of the maximum values described above. For example, the plurality of zeolite nanotubes can have an average length of from 20 nanometers (nm) to 10 micrometers (μm, microns) (e.g., from 25 nm to 1 μm, from 1 μm to 10 μm, from 25 nm to 250 nm, from 250 nm to 500 nm, from 500 nm to 750 nm, from 750 nm to 1 μm, from 1 μm to 5 μm, from 5 μm to 10 μm, from 25 nm to 10 μm, from 20 nm to 9 μm, from 25 nm to 9 μm, from 250 nm to 5 μm, or from 500 nm to 1 μm).

In some examples, the plurality of zeolite nanotubes can be substantially monodisperse in length. “Monodisperse” and “homogeneous length distribution” are used interchangeably herein, and generally describe a population of nanotubes where all of the nanotubes have the same or nearly the same length. As used herein, a monodisperse distribution refers to distributions in which 90% of the distribution lies within 25% of the mean nanotube length (e.g., within 20% of the mean nanotube length, within 15% of the mean nanotube length, within 10% of the mean nanotube length, or within 5% of the mean nanotube length).

The plurality of zeolite nanotubes can, for example, have an average outer diameter (e.g., defined by the outer surface of the zeolitic wall). “Average outer diameter” and “mean outer diameter” are used interchangeably herein, and generally refer to the statistical mean outer diameter of the nanotubes in a population of nanotubes. Mean outer diameter can be measured using methods known in the art, such as evaluation by scanning electron microscopy, transmission electron microscopy, and/or dynamic light scattering.

In some examples, the plurality of zeolite nanotubes have an average outer diameter of 1 nanometer (nm) or more (e.g., 1.5 nm or more, 2 nm or more, 2.5 nm or more, 3 nm or more, 3.5 nm or more, 4 nm or more, 4.5 nm or more, 5 nm or more, 5.5 nm or more, 6 nm or more, 6.5 nm or more, 7 nm or more, 7.5 nm or more, 8 nm or more, 8.5 nm or more, 9 nm or more, or 9.5 nm or more). In some examples, the plurality of zeolite nanotubes have an average outer diameter of 10 nanometers (nm) or less (e.g., 9.5 nm or less, 9 nm or less, 8.5 nm or less, 8 nm or less, 7.5 nm or less, 7 nm or less, 6.5 nm or less, 6 nm or less, 5.5 nm or less, 5 nm or less, 4.5 nm or less, 4 nm or less, 3.5 nm or less, 3 nm or less, 2.5 nm or less, 2 nm or less, or 1.5 nm or less). The average outer diameter can range from any of the minimum values described above to any of the maximum values described above. For example, the plurality of zeolite nanotubes can have an average outer diameter of from 1 nanometer to 10 nanometers (e.g., from 1 nm to 5 nm, from 5 nm to 10 nm, from 1 nm to 4 nm, from 4 nm to 7 nm, from 7 nm to 10 nm, from 2 nm to 10 nm, from nm to 9 nm, from 2 nm to 9 nm, from 3 nm to 8 nm, or from 4 nm to 6 nm).

In some examples, the plurality of zeolite nanotubes can be substantially monodisperse in outer diameter. “Monodisperse” and “homogeneous outer diameter distribution” are used interchangeably herein, and generally describe a population of nanotubes where all of the nanotubes have the same or nearly the same outer diameter. As used herein, a monodisperse distribution refers to distributions in which 90% of the distribution lies within 25% of the mean nanotube outer diameter (e.g., within 20% of the mean nanotube outer diameter, within 15% of the mean nanotube outer diameter, within 10% of the mean nanotube outer diameter, or within 5% of the mean nanotube outer diameter).

In some examples, the plurality of zeolite nanotubes can be described by their aspect ratio, which, as used herein, is the length of a nanotube divided by the outer diameter of a nanotube. For example, the plurality of zeolite nanotubes can have an average aspect ratio of 2 or more (e.g., 3 or more; 4 or more; 5 or more; 10 or more; 15 or more; 20 or more; 25 or more; 30 or more; 35 or more; 40 or more; 45 or more; 50 or more; 60 or more; 70 or more; 80 or more; 90 or more; 100 or more; 125 or more; 150 or more; 175 or more; 200 or more; 225 or more; 250 or more; 300 or more; 350 or more; 400 or more; 450 or more; 500 or more; 600 or more; 700 or more; 800 or more; 900 or more; 1,000 or more; 1,250 or more; 1,500 or more; 1,750 or more; 2,000 or more; 2,250 or more; 2,500 or more; 3,000 or more; 3,500 or, more; 4,000 or more; 4,500 or more; 5,000 or more; 6,000 or more; 7,000 or more; 8,000 or more; or 9,000 or more). In some examples, the plurality of zeolite nanotubes can have an average aspect ratio of 10,000 or less (e.g., 9,000 or less; 8,000 or less; 7,000 or less; 6,000 or less; 5,000 or less; 4,500 or less; 4,000 or less; 3,500 or less; 3,000 or less; 2,500 or less; 2,250 or less; 2,000 or less; 1,750 or less; 1,500 or less; 1,250 or less; 1,000 or less; 900 or less; 800 or less; 700 or less; 600 or less; 500 or less; 450 or less; 400 or less; 350 or less; 300 or less; 250 or less; 225 or less; 200 or less; 175 or less; 150 or less; 125 or less; 100 or less; 90 or less; 80 or less; 70 or less; 60 or less; 50 or less; 45 or less; 40 or less; 35 or less; 30 or less; 25 or less; 20 or less; 15 or less; 10 or less; or 5 or less). The average aspect ratio of the plurality of zeolite nanotubes can range from any of the minimum values described above to any of the maximum values described above. For example, the plurality of zeolite nanotubes can have an average aspect ratio of from 2 to 10,000 (e.g., from 2 to 1,000; from 1,000 to 10,000; from 2 to 20; from 20 to 200; from 200 to 2,000; from 2,000 to 10,000; from 5 to 10,000; from 2 to 9,000; from 5 to 9,000; from 10 to 7,000; from 25 to 5,000; from 40 to 1,000; from 50 to 500; or from 100 to 200).

The plurality of zeolite nanotubes can, for example, have an average inner diameter (e.g., the diameter of the lumen defined by the inner surface of the zeolitic wall). “Average inner diameter” and “mean inner diameter” are used interchangeably herein, and generally refer to the statistical mean inner diameter of the nanotubes in a population of nanotubes. Mean inner diameter can be measured using methods known in the art, such as evaluation by scanning electron microscopy, transmission electron microscopy, dynamic light scattering, and/or N₂ physisorption.

In some examples, the plurality of zeolite nanotubes have an average inner diameter of 0.5 nm or more (e.g., 0.75 nm or more, 1 nm or more, 1.25 nm or more, 1.5 nm or more, 1.75 nm or more, 2 nm or more, 2.5 nm or more, 3 nm or more, 3.5 nm or more, 4 nm or more, 4.5 nm or more, 5 nm or more, 5.5 nm or more, 6 nm or more, 6.5 nm or more, 7 nm or more, 7.5 nm or more, 8 nm or more, or 8.5 nm or more). In some examples, the plurality of zeolite nanotubes can have an average inner diameter of 9 nm or less (e.g., 8.5 nm or less, 8 nm or less, 7.5 nm or less, 7 nm or less, 6.5 nm or less, 6 nm or less, 5.5 nm or less, 5 nm or less, 4.5 nm or less, 4 nm or less, 3.5 nm or less, 3 nm or less, 2.5 nm or less, 2 nm or less, 1.75 nm or less, 1.5 nm or less, 1.25 nm or less, 1 nm or less, or 0.75 nm or less). The average inner diameter of the plurality of zeolite nanotubes can range from any of the minimum values described above to any of the maximum values described above. For example, the plurality of zeolite nanotubes can have an average inner diameter of from 0.5 nm to 9 nm (e.g., from 0.5 nm to 4.5 nm, from 4.5 nm to 9 nm, from 0.5 nm to 3 nm, from 3 nm to 6 nm, from 6 nm to 9 nm, from 1 nm to 9 nm, from 0.5 nm to 8 nm, from 1 nm to 8 nm, from 1 nm to 5 nm, or from 2 nm to 4 nm).

In some examples, the plurality of zeolite nanotubes can be substantially monodisperse in inner diameter. “Monodisperse” and “homogeneous inner diameter distribution” are used interchangeably herein, and generally describe a population of nanotubes where all of the nanotubes have the same or nearly the same inner diameter. As used herein, a monodisperse distribution refers to distributions in which 90% of the distribution lies within 25% of the mean nanotube inner diameter (e.g., within 20% of the mean nanotube inner diameter, within 15% of the mean nanotube inner diameter, within 10% of the mean nanotube inner diameter, or within 5% of the mean nanotube inner diameter).

In some examples, the plurality of zeolite nanotubes can be described by their average wall thickness, which, as used herein, is half the difference between the average outer diameter and the average inner diameter of a nanotube (e.g., (average outer diameter−average inner diameter)/2). “Average wall thickness” and “mean wall thickness” are used interchangeably herein, and generally refer to the statistical mean wall thickness of the nanotubes in a population of nanotubes. Mean wall thickness can be measured using methods known in the art, such as evaluation by electron microscopy.

In some examples, the plurality of zeolite nanotubes have an average wall thickness of 0.5 nm or more (e.g., 0.75 nm or more, 1 nm or more, 1.25 nm or more, 1.5 nm or more, 1.75 nm or more, 2 nm or more, 2.5 nm or more, 3 nm or more, 3.5 nm or more, 4 nm or more, or 4.5 nm or more). In some examples, the plurality of zeolite nanotubes can have an average wall thickness of 5 nm or less (e.g., 4.5 nm or less, 4 nm or less, 3.5 nm or less, 3 nm or less, 2.5 nm or less, 2 nm or less, 1.75 nm or less, 1.5 nm or less, 1.25 nm or less, 1 nm or less, or 0.75 nm or less). The average wall thickness of the plurality of zeolite nanotubes can range from any of the minimum values described above to any of the maximum values described above. For example, the plurality of zeolite nanotubes can have an average wall thickness of from 0.5 nm to 5 nm (e.g., from 0.5 nm to 2.5 nm, from 2.5 nm to 5 nm, from 0.5 nm to 1 nm, from 1 nm to 2 nm, from 2 nm to 3 nm, from 3 nm to 4 nm, from 4 nm to 5 nm, from 0.75 nm to 5 nm, from 0.5 nm to 4.5 nm, from 0.75 nm to 4.5 nm, from 0.5 nm to 4 nm, from 0.5 nm to 3 nm, or from 0.5 nm to 2 nm).

In some examples, the plurality of zeolite nanotubes can be substantially monodisperse in wall thickness. “Monodisperse” and “homogeneous wall thickness distribution” are used interchangeably herein, and generally describe a population of nanotubes where all of the nanotubes have the same or nearly the same wall thickness. As used herein, a monodisperse distribution refers to distributions in which 90% of the distribution lies within 25% of the mean nanotube wall thickness (e.g., within 20% of the mean nanotube wall thickness, within 15% of the mean nanotube wall thickness, within 10% of the mean nanotube wall thickness, or within 5% of the mean nanotube wall thickness).

Each zeolite nanotube comprises a zeolitic wall perforated by a plurality of pores, such that the plurality of zeolite nanotubes can be porous.

In some examples the plurality of pores can have an average diameter. “Average diameter” and “mean diameter” are used interchangeably herein, and generally refer to the statistical mean inner diameter of the pores in a population of pores. Mean diameter can be measured using methods known in the art, such as using the Horvath-Kawazoe method.

In some examples, the plurality of pores can have an average diameter of 0.2 nm or more (e.g., 0.3 nm or more, 0.4 nm or more, 0.5 nm or more, 0.6 nm or more, 0.7 nm or more, 0.8 nm or more, 0.9 nm or more, 1 nm or more, 1.1 nm or more, 1.2 nm or more, 1.3 nm or more, 1.4 nm or more, 1.5 nm or more, 1.6 nm or more, 1.7 nm or more, 1.8 nm or more, or 1.9 nm or more). In some examples, the plurality of pores can have an average diameter of 2 nm or less (e.g., 1.9 nm or less, 1.8 nm or less, 1.7 nm or less, 1.6 nm or less, 1.5 nm or less, 1.4 nm or less, 1.3 nm or less, 1.2 nm or less, 1.1 nm or less, 1 nm or less, 0.9 nm or less, 0.8 nm or less, 0.7 nm or less, 0.6 nm or less, 0.5 nm or less, 0.4 nm or less, or 0.3 nm or less). The average diameter of the plurality of pores can range from any of the minimum values described above to any of the maximum values described above. For example, the plurality of pores can have an average diameter of from 0.2 to 2 nm (e.g., from 0.2 nm to 1 nm, from 1 nm to 2 nm, from 0.2 nm to 0.5 nm, from 0.5 nm to 1 nm, from 1 nm to 1.5 nm, from 1.5 nm to 2 nm, from 0.3 nm to 2 nm, from 0.2 nm to 1.9 nm, from 0.3 nm to 1.9 nm, from 0.2 nm to 1.5 nm, from 0.2 nm to 0.9 nm, from 0.3 nm to 0.8 nm, from 0.4 nm to 0.7 nm, or from 0.4 to 0.6 nm).

In some examples, the plurality of pores can be substantially monodisperse in diameter. “Monodisperse” and “homogeneous diameter distribution” are used interchangeably herein, and generally describe a population of pores where all of the pores have the same or nearly the same diameter. As used herein, a monodisperse distribution refers to pore distributions in which 90% of the distribution lies within 25% of the mean diameter (e.g., within 20% of the mean diameter, within 15% of the mean diameter, within 10% of the mean diameter, or within 5% of the mean nanotube inner diameter).

In some examples, the average diameter of the plurality of pores and the average diameter of the lumen (e.g., the average inner diameter of the plurality of zeolite nanotubes) can be hierarchical in size relative to each other. In some examples, the lumen of each of the plurality of zeolite nanotubes can be considered an elongated pore, such that the plurality of pores and the lumen together can comprise hierarchical pores. “Hierarchical pores,” as used herein, generally refer to pores that span two or more different length scales. Thus, “hierarchically porous materials” are materials which contain pores that span two or more length scales. In some examples, there can be a distribution of pore diameters at each length scale, where often the distributions of pore diameters are sufficiently narrow that there is little or no overlap between the pore size distributions. In some examples, the nanostructured zeolitic materials disclosed herein comprise hierarchically porous materials.

The average length of the plurality of zeolite nanotubes, the average outer diameter of the plurality of zeolite nanotubes, the average inner diameter of the plurality of zeolite nanotubes, the average wall thickness of the plurality of zeolite nanotubes, the composition of the plurality of zeolite nanotubes, the average diameter of the plurality of pores, or a combination thereof can be selected in view of a variety of factors.

In some examples, the plurality of zeolite nanotubes comprise: a first population of nanotubes comprising a first material and having a first average length, a first average outer diameter, a first average inner diameter, a first average wall thickness, a first plurality of pores having a first average diameter, and a first average aspect ratio; and a second population of nanotubes comprising a second material and having a second average length, a second average outer diameter, a second average inner diameter, a second average wall thickness, a second plurality of pores having a second average diameter, and a second average aspect ratio; wherein the first average length and the second average length are different, the first average outer diameter and the second average outer diameter are different, the first average inner diameter and the second average inner diameter are different, the first average wall thickness and the second average wall thickness are different, the first average diameter of the first plurality of pores and the second average diameter of the second plurality of pores are different, the first average aspect ratio and the second average aspect ratio are different, the first material and the second material are different, or a combination thereof. In some examples, the plurality of zeolite nanotubes can comprise a mixture of a plurality of populations of nanotubes, wherein each population of nanotubes within the mixture has a different average length, average outer diameter, average inner diameter, average wall thickness, average aspect ratio, average diameter of the plurality of pores, composition, or combination thereof.

In some examples, the plurality of zeolite nanotubes can have an average surface area of 500 or more meters squared per gram of the plurality of zeolite nanotubes (m²/g) (e.g., 550 m²/g or more, 600 m²/g or more, 650 m²/g or more, 700 m²/g or more, 750 m²/g or more, 800 m²/g or more, 850 m²/g or more, 900 m²/g or more, 950 m²/g or more, 1000 m²/g or more, 1100 m²/g or more, 1200 m²/g or more, 1300 m²/g or more, 1400 m²/g or more, 1500 m²/g or more, 1600 m²/g or more, 1700 m²/g or more, 1800 m²/g or more, 1900 m²/g or more, 2000 m²/g or more, 2250 m²/g or more, 2500 m²/g or more, 2750 m²/g or more, 3000 m²/g or more, 3250 m²/g or more, 3500 m²/g or more, 3750 m²/g or more, 4000 m²/g or more, 4250 m²/g or more, 4500 m²/g or more, or 4750 m²/g or more). In some examples, the plurality of zeolite nanotubes can have an average surface area of 5000 m²/g or less (e.g., 4750 m²/g or less, 4500 m²/g or less, 4250 m²/g or less, 4000 m²/g or less, 3750 m²/g or less, 3500 m²/g or less, 3250 m²/g or less, 3000 m²/g or less, 2750 m²/g or less, 2500 m²/g or less, 2250 m²/g or less, 2000 m²/g or less, 1900 m²/g or less, 1800 m²/g or less, 1700 m²/g or less, 1600 m²/g or less, 1500 m²/g or less, 1400 m²/g or less, 1300 m²/g or less, 1200 m²/g or less, 1100 m²/g or less, 1000 m²/g or less, 950 m²/g or less, 900 m²/g or less, 850 m²/g or less, 800 m²/g or less, 750 m²/g or less, 700 m²/g or less, 650 m²/g or less, 600 m²/g or less, or 550 m²/g or less). The average surface area of the plurality of zeolite nanotubes can range from any of the minimum values described above to any of the maximum values described above. For example, the plurality of zeolite nanotubes can have an average surface area of from 500 to 5000 meters squared per gram of the plurality of zeolite nanotubes (m²/g) (e.g., from 500 m²/g to 2500 m²/g, from 2500 m²/g to 5000 m²/g, from 500 m²/g to 1000 m²/g, from 1000 m²/g to 1500 m²/g, from 1500 m²/g to 2000 m²/g, from 2000 m²/g to 2500 m²/g, from 2500 m²/g to 3000 m²/g, from 3000 m²/g to 3500 m²/g, from 3500 m²/g to 4000 m²/g, from 4000 m²/g to 4500 m²/g, from 4500 m²/g to 5000 m²/g, from 550 m²/g to 5000 m²/g, from 500 m²/g to 4500 m²/g, from 550 m²/g to 4500 m²/g, from 600 m²/g to 500 m²/g, from 700 m²/g to 5000 m²/g, from 800 m²/g to 5000 m²/g, from 900 m²/g to 5000 m²/g, from 1000 m²/g to 5000 m²/g, or from 950 to 1000 m²/g). The average surface area can, for example, be determined by BET.

In some examples, the plurality of zeolite nanotubes can further comprise a structure directing agent. For example, the structure directing agent can be disposed within at least a portion of the plurality of pores.

In some examples, the structure directing agent comprises a bolaform structure directing agent. In some examples, the bolaform structure directing agent comprises a first hydrophilic end and a second hydrophilic end with a hydrophobic core therebetween.

The hydrophobic core can, for example, comprise one or more aromatic rings, one or more hydrophobic alkyl groups, or a combination thereof. In some examples, the hydrophobic core comprises one or more aromatic rings, and the one or more aromatic rings comprises a substituted or unsubstituted biphenyl group, a substituted or unsubstituted naphthalene group, a substituted or unsubstituted anthracene group, a substituted or unsubstituted pyrene group, or a combination thereof. In some examples, the hydrophobic core comprises one or more aromatic rings, and the one or more aromatic rings comprises a substituted or unsubstituted biphenyl group.

In some examples, the hydrophobic core comprise one or more hydrophobic alkyl groups, and the one or more hydrophobic alkyl groups each independently comprises a substituted or unsubstituted C₁-C₂₀ alkyl group (e.g., from C₄-C₂₀ alkyl, from C₆-C₂₀ alkyl, from C₈-C₂₀ alkyl, or from C₈-C₁₂ alkyl). In some examples, the hydrophobic core comprise one or more hydrophobic alkyl groups, and the one or more hydrophobic alkyl groups each independently comprises a substituted or unsubstituted C₁₀ alkyl group. In some examples, the hydrophobic core comprises one or more substituted or unsubstituted biphenyl group and one or more substituted or unsubstituted C₁₀ alkyl groups.

The first hydrophilic end and the second hydrophilic end each independently comprises a hydrophilic group. Examples of hydrophilic groups are known in the art. In some examples, the first hydrophilic end and the second hydrophilic end each independently comprises a quinuclidinium group.

In some examples, the structure directing agent comprises a molecule with the following structure.

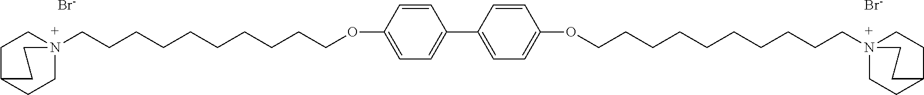

Impregnated Nanostructured Zeolitic Materials

Also disclosed herein are compositions comprising an impregnated nanostructured hierarchical zeolitic material comprising a plurality of zeolite nanotubes, wherein each zeolite nanotube comprises a zeolitic wall perforated by a plurality of pores, the zeolitic wall defining a single longitudinal lumen, and wherein at least a portion of the plurality of zeolite nanotubes are impregnated with an amine (e.g., some or all of the zeolite nanotubes are impregnated with an amine). In some of the examples, each of the plurality of zeolite nanotubes is impregnated with the amine.

The plurality of zeolite nanotubes can comprise any of the nanostructured zeolitic materials described herein. In some examples, the plurality of zeolite nanotubes can comprise those described in WO 2022/031951, which is incorporated by reference herein in its entirety

The term “amine,” as used herein, may include a primary amine, a secondary amine, a tertiary amine, or a combination thereof. The amine can comprise any suitable amine, such as those known in the art. Suitable amines are described, for example in US 2014/0241966; Chaikittisilp et al. Ind. Eng. Chem. Res. 2011, 50, 14203-14210; Kumar et al. ACS Sustainable Chem. Eng. 2020, 8, 10971-10982; Okonkwo et al. Chemical Engineering Journal, 2020, 379, 122349; Okonkwo et al. ACS Sustainable Chem. Eng. 2020, 8, 10102-10114; Pang et al. JACS, 2017, 139, 3627-3630; Pang et al. ChemSusChem, 2018, 11, 2628-2637; Sarazen et al. Macromolecules, 2017, 50, 9135-9143; Sarazen et al. ACS Sustainable Chem. Eng. 2019, 7, 7338-7345; and Sujan et al. ACS Appl. Poly. Mater. 2019, 1, 3137-3147; each of which is hereby incorporated herein by reference for its description of amines, sorbents comprising said amines, and methods of making and use thereof.

In some examples, the amine can comprise a small molecule, an aliphatic-aryl amine, a sterically hindered amine, an aminopolymer, or a combination thereof.

In some examples, the amine can comprise a small molecule such as monoethanolamine (MEA), diethanolamine (DEA), an amino acid (e.g., lysine, glutamic acid), or a combination thereof.

In some examples, the amine can comprise an aliphatic-aryl amine. In some examples, the amine can comprise an aliphatic-aryl amine of Formula I:

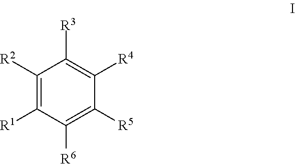

wherein R¹, R², R³, R⁴, R⁵, and R⁶ are each independently H or an aliphatic amine (e.g., a substituted or unsubstituted C₁-C₂₀ aliphatic amine).

In some examples of Formula I, R¹-R⁶ are each independently a substituted or unsubstituted C₁-C₂₀ aliphatic amine. In some examples of Formula I, R¹-R⁶ are each independently a substituted or unsubstituted C₁-C₁₀ aliphatic amine. In some examples of Formula I, R¹-R⁶ are each independently ethylenediamine or propylenediamine. In some examples of Formula I, R¹-R⁶ are the same.

In some examples of Formula I, R², R⁴, and R⁶ are each hydrogen. In some examples, the amine can comprise an aliphatic-aryl amine or Formula IA:

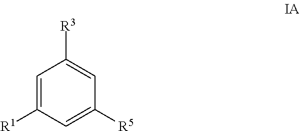

wherein R¹, R³, and R⁵ are each independently H or an aliphatic amine (e.g., a substituted or unsubstituted C₁-C₂₀ aliphatic amine).

In some examples of Formula IA, R¹, R³, and R⁵ each independently a substituted or unsubstituted C₁-C₂₀ aliphatic amine. In some examples of Formula IA, R¹, R³, and R⁵ are each independently a substituted or unsubstituted C₁-C₁₀ aliphatic amine. In some examples of Formula IA, R¹, R³, and R⁵ are each independently ethylenediamine or propylenediamine. In some examples of Formula IA, R¹, R³, and R⁵ are the same.

In some examples, the amine is sterically hindered. Examples of sterically hindered amines include, but are not limited to, tert-butylaminopropyltrimethoxysilane (TBAPS), (N,N-dimethylaminopropyl)trimethoxysilane (DMAPS), (N-cyclohexylaminopropyl)trimethoxysilane (CHAPS), (3-amino-3-methylbutyl)trimethoxysilane (AMBS), derivatives thereof, and combinations thereof.

In some examples, the amine comprises an aminopolymer. The aminopolymer can, for example, be branched and/or linear. Examples of suitable aminopolymers include, but are not limited to, poly(allylamine) (PAA), poly(glycidyl amine) (PGA), poly(propyleneimine) (PPI), poly(ethyleneimine) (PEI), derivatives thereof, or combinations thereof.

In some examples, the amine comprises poly(ethyleneimine). In some examples, the amine comprises branched poly(ethyleneimine), linear poly(ethyleneimine), or a combination thereof. In some examples, the amine comprises branched poly(ethyleneimine).

The materials can be impregnated with any suitable amount of the amine.

In some examples, the material comprises the amine in an amount of greater than 0 w/w % (e.g., 1 w/w % or more, 2 w/w % or more, 3 w/w % or more, 4 w/w % or more, 5 w/w % or more, 10 w/w % or more, 15 w/w % or more, 20 w/w % or more, 25 w/w % or more, 30 w/w % or more, 35 w/w % or more, 40 w/w % or more, 45 w/w % or more, 50 w/w % or more, 55 w/w % or more, 60 w/w % or more, 65 w/w % or more, 70 w/w % or more, 75 w/w % or more, 80 w/w % or more, 85 w/w % or more, 90 w/w % or more, 95 w/w % or more, 100 w/w % or more, 105 w/w % or more, 110 w/w % or more, or 115 w/w % or more). In some examples, the material comprises the amine in an amount of 120 w/w % or less (e.g., 115 w/w % or less, 110 w/w % or less, 105 w/w % or less, 100 w/w % or less, 95 w/w % or less, 90 w/w % or less, 85 w/w % or less, 80 w/w % or less, 75 w/w % or less, 70 w/w % or less, 65 w/w % or less, 60 w/w % or less, 55 w/w % or less, 50 w/w % or less, 45 w/w % or less, 40 w/w % or less, 35 w/w % or less, 30 w/w % or less, 25 w/w % or less, 20 w/w % or less, 15 w/w % or less, 10 w/w % or less, 5 w/w % or less, 4 w/w % or less, 3 w/w % or less, 2 w/w % or less, or 1 w/w % or less). The amount of amine impregnated in the material can range from any of the minimum values described above to any of the maximum values described above. For example, the material can comprise the amine in an amount of from greater than 0 to 120 w/w % (e.g., from greater than 0 to 60 w/w %, from 60 to 120 w/w %, from greater than 0 to 40 w/w %, from 40 to 80 w/w %, from 80 to 120 w/w %, from greater than 0 to 110 w/w %, from greater than 0 to 100 w/w %, from greater than 0 to 90 w/w %, from greater than 0 to 80 w/w %, from greater than 0 to 70 w/w %, from greater than 0 to 50 w/w %, from greater than 0 to 30 w/w %, from greater than 0 to 20 w/w %, from 1 to 120 w/w %, from 5 to 120 w/w %, from 10 to 120 w/w %, from 20 to 120 w/w %, from 30 to 120 w/w %, from 40 to 120 w/w %, from 50 to 120 w/w %, from 70 to 120 w/w %, from 80 to 120 w/w %, from 90 to 120 w/w %, from 100 to 120 w/w %, from greater than 0 to less than 100 w/w %, from 20 w/w % to 80 w/w %, from 50 to 80 w/w %, from 60 to 80 w/w %, from 50 to 70 w/w %, or from 60 to 70 w/w %).

Methods of Making

Also disclosed herein are methods of making and using any of the impregnated nanostructured zeolitic materials described herein, e.g., for CO₂ capture.

In some examples, the methods comprise impregnating at least a portion of the nanostructured zeolitic materials with the amine, for example using wet impregnation (e.g., solvent impregnation). For example, the methods can comprise contacting at least a portion of the nanostructured zeolitic material with the amine. In some examples, the methods can comprise contacting a first dispersion with a second dispersion to form a mixture, the first dispersion comprising at least a portion of the nanostructured zeolitic material dispersed in a first solvent, and the second dispersion comprising the amine dispersed in a second solvent.

The first solvent and the second solvent can be the same or different. The first solvent and/or the second solvent can, for example, comprise tetrahydrofuran (THF), N-methyl-2-pyrrolidone (NMP), dimethylformamide (DMF), N-methylformamide, formamide, dichloromethane (CH₂Cl₂), ethylene glycol, polyethylene glycol, glycerol, alkane diol, ethanol, methanol, propanol, isopropanol, water, acetonitrile, chloroform, toluene, methyl acetate, ethyl acetate, acetone, hexane, heptane, tetraglyme, propylene carbonate, diglyme, dimethyl sulfoxide (DMSO), dimethoxyethane, xylene, dimethylacetamide, methylene chloride, hexafluoro-2-propanol, or combinations thereof.

In some examples, the methods further comprise agitating the first dispersion, the second dispersion, the mixture, or a combination thereof. Agitating the first dispersion, the second dispersion, the mixture, or a combination thereof can be accomplished, for example, by mechanical stirring, shaking, vortexing, sonication (e.g., bath sonication, probe sonication, ultrasonication), and the like, or combinations thereof.

In some examples, the methods further comprise making the nanostructured zeolitic material. Additional description of the preparation of zeolite nanotubes is provided in WO 2022/031951, which is incorporated by reference herein in its entirety.

In some examples, the methods of making the nanostructured zeolitic material can comprise hydrothermal zeolite growth using a structure directing agent, such as a bolaform structure directing agent.

For example, the methods can comprise dispersing a precursor and the structure directing agent in a solvent for form a mixture. The solvent can, for example, comprise tetrahydrofuran (THF), N-methyl-2-pyrrolidone (NMP), dimethylformamide (DMF), N-methylformamide, formamide, dichloromethane (CH₂Cl₂), ethylene glycol, polyethylene glycol, glycerol, alkane diol, ethanol, methanol, propanol, isopropanol, water, acetonitrile, chloroform, toluene, methyl acetate, ethyl acetate, acetone, hexane, heptane, tetraglyme, propylene carbonate, diglyme, dimethyl sulfoxide (DMSO), dimethoxyethane, xylene, dimethylacetamide, methylene chloride, hexafluoro-2-propanol, or combinations thereof. In some examples, solvent comprises water.

The methods can, in some examples, further comprise heating the mixture at a temperature of 90° C. or more (e.g., 100° C. or more, 110° C. or more, 120° C. or more, 130° C. or more, 140° C. or more, 150° C. or more, 160° C. or more, 170° C. or more, 180° C. or more, 190° C. or more, 200° C. or more, 210° C. or more, 220° C. or more, 230° C. or more, 240° C. or more, or 250° C. or more). In some examples, the methods can further comprise heating the mixture at a temperature of 260° C. or less (e.g., 250° C. or less, 240° C. or less, 230° C. or less, 220° C. or less, 210° C. or less, 200° C. or less, 190° C. or less, 180° C. or less, 170° C. or less, 160° C. or less, 150° C. or less, 140° C. or less, 130° C. or less, 120° C. or less, 110° C. or less, or 100° C. or less). The temperature at which the mixture is heated can range from any of the minimum values described above to any of the maximum values described above. For example, the methods can further comprise heating the mixture at a temperature of from 90° C. to 260° C. (e.g., from 90° C. to 175° C., from 175° C. to 260° C., from 90° C. to 120° C., from 120° C. to 150° C., from 150° C. to 180° C., from 180° C. to 210° C., from 210° C. to 260° C., from 95° C. to 260° C., from 90° C. to 255° C., or from 95° C. to 255° C.).

The methods can, in some examples, further comprise heating the mixture at a temperature for an amount of time of 1 hour or more (e.g., 2 hours or more, 3 hours or more, 4 hours or more, 5 hours or more, 6 hours or more, 12 hours or more, 18 hours or more, 1 day or more, 2 days or more, 3 days or more, 4 days or more, 5 days or more, 6 days or more, 7 days or more, 8 days or more, 9 days or more, 10 days or more, 11 days or more, 12 days or more, or 13 days or more). In some examples, the methods can further comprise heating the mixture at a temperature for an amount of time of 2 weeks or less (e.g., 13 days or less, 12 days or less, 11 days or less, 10 days or less, 9 days or less, 8 days or less, 7 days or less, 6 days or less, 5 days or less, 4 days or less, 3 days or less, 2 days or less, 1 days or less, 18 hours or less, 12 hours or less, 6 hours or less, 5 hours or less, 4 hours or less, 3 hours or less, or 2 hours or less). The amount of time for which the mixture is heated can range from any of the minimum values described above to any of the maximum values described above. For example, the methods can further comprise heating the mixture at a temperature for an amount of time of from 1 hour to 2 weeks (e.g., from 1 hour to 1 day, from 1 day to 1 week, from 1 week to 2 weeks, from 2 hours to 2 weeks, from 1 hour to 13 days, from 2 hours to 13 days, or from 5 days to 2 weeks).

In some examples, the plurality of zeolite nanotubes can be synthesized using a bolaform structure directing agent. In some examples, the structure directing agent comprises a bolaform structure directing agent. In some examples, the bolaform structure directing agent comprises a first hydrophilic end and a second hydrophilic end with a hydrophobic core therebetween.

The hydrophobic core can, for example, comprise one or more aromatic rings, one or more hydrophobic alkyl groups, or a combination thereof. In some examples, the hydrophobic core comprises one or more aromatic rings, and the one or more aromatic rings comprises a substituted or unsubstituted biphenyl group, a substituted or unsubstituted naphthalene group, a substituted or unsubstituted anthracene group, a substituted or unsubstituted pyrene group, or a combination thereof. In some examples, the hydrophobic core comprises one or more aromatic rings, and the one or more aromatic rings comprises a substituted or unsubstituted biphenyl group. In some examples, the hydrophobic core comprises one or more hydrophobic alkyl groups, and the one or more hydrophobic alkyl groups each independently comprises a substituted or unsubstituted C₁-C₂₀ alkyl group (e.g., from C₄-C₂₀ alkyl, from C₆-C₂₀ alkyl, from C₈-C₂₀ alkyl, or from C₈-C₁₂ alkyl). In some examples, the hydrophobic core comprise one or more hydrophobic alkyl groups, and the one or more hydrophobic alkyl groups each independently comprises a substituted or unsubstituted C₁₀ alkyl group. In some examples, the hydrophobic core comprises one or more substituted or unsubstituted biphenyl group and one or more substituted or unsubstituted C₁₀ alkyl groups.

The first hydrophilic end and the second hydrophilic end each independently comprises a hydrophilic group. Examples of hydrophilic groups are known in the art. In some examples, the first hydrophilic end and the second hydrophilic end each independently comprises a quinuclidinium group.

In some examples, the structure directing agent comprises a molecule with the following structure.

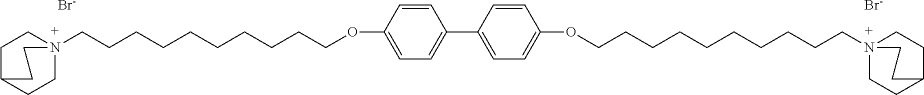

In some examples, the methods can further comprise making the structure directing agent.

In some examples, the methods can further comprise calcination, for example to remove the structure directing agent from the plurality of zeolite nanotubes.

Methods of Use

Also disclosed herein are methods of using any of the impregnated nanostructured zeolitic materials described herein. For example, the methods can comprise using the material as an adsorbent, in a chemical separation, or a combination thereof.

In some examples, the methods can comprise using the material as a CO₂ adsorbent, in a CO₂ separation, or a combination thereof. In some examples, the methods can comprise using the material as a H₂S adsorbent, in a H₂S separation, or a combination thereof.

Also disclosed herein are methods of use of any of the materials disclosed herein for CO₂ capture and/or storage. In some examples, the impregnated nanostructured zeolitic material can capture 1.8 mmol CO₂ per gram of material or more (e.g., 1.9 mmol CO₂/gram or more, 2 mmol CO₂/gram or more, 2.1 mmol CO₂/gram or more, 2.2 mmol CO₂/gram or more, 2.3 mmol CO₂/gram or more, 2.4 mmol CO₂/gram or more, or 2.5 mmol CO₂/gram or more). In some examples, the impregnated nanostructured zeolitic material can capture CO₂ at a rate of 2 mmol CO₂ per gram of material per minute or more (e.g., 3 mmol CO₂g⁻¹ₘₐₜₑᵣᵢₐₗmin⁻¹ or more, 4 mmol CO₂g⁻¹ₘₐₜₑᵣᵢₐₗmin⁻¹ or more, 5 mmol CO₂g⁻¹ₘₐₜₑᵣᵢₐₗmin⁻¹ or more, 6 mmol CO₂g⁻¹ₘₐₜₑᵣᵢₐₗmin⁻¹ or more, 7 mmol CO₂g⁻¹ₘₐₜₑᵣᵢₐₗmin⁻¹ or more, 8 mmol CO₂g⁻¹ₘₐₜₑᵣᵢₐₗmin⁻¹ or more, 9 mmol CO₂g⁻¹ₘₐₜₑᵣᵢₐₗmin⁻¹ or more, or 10 mmol CO₂g⁻¹ₘₐₜₑᵣᵢₐₗmin⁻¹ or more).

Also disclosed herein are methods of use of any of the materials disclosed herein for H₂S capture and/or storage.

Also disclosed herein are filters for separating a component from a fluid stream, the filters comprising any of the materials disclosed herein.

Also disclosed herein are methods of use of the filters, the methods comprising using the filters in a separation to separate the component from the fluid stream.

In some examples, the component separated from the fluid stream comprises CO₂. In some examples, the concentration of CO₂ in the fluid stream is 0.04% or more (e.g., 0.05% or more, 0.1% or more, 0.15% or more, 0.2% or more, 0.25% or more, 0.5% or more, 0.75% or more, 1% or more, 2% or more, 3% or more, 4% or more, 5% or more, 6% or more, 7% or more, 8% or more, 9% or more, or 10% or more). In some examples, the material captures 1.8 mmol CO₂ per gram of material or more (e.g., 1.9 mmol CO₂/gram or more, 2 mmol CO₂/gram or more, 2.1 mmol CO₂/gram or more, 2.2 mmol CO₂/gram or more, 2.3 mmol CO₂/gram or more, 2.4 mmol CO₂/gram or more, or 2.5 mmol CO₂/gram or more). In some examples, the material can capture CO₂ at a rate of 2 mmol CO₂ per gram of material per minute or more (e.g., 3 mmol CO₂g⁻¹ₘₐₜₑᵣᵢₐₗmin⁻¹ or more, 4 mmol CO₂g⁻¹ₘₐₜₑᵣᵢₐₗmin⁻¹ or more, 5 mmol CO₂g⁻¹ₘₐₜₑᵣᵢₐₗmin⁻¹ or more, 6 mmol CO₂g⁻¹ₘₐₜₑᵣᵢₐₗmin⁻¹ or more, 7 mmol CO₂g⁻¹ₘₐₜₑᵣᵢₐₗmin⁻¹ or more, 8 mmol CO₂g⁻¹ₘₐₜₑᵣᵢₐₗmin⁻¹ or more, 9 mmol CO₂g⁻¹ₘₐₜₑᵣᵢₐₗmin⁻¹ or more, or 10 mmol CO₂g⁻¹ₘₐₜₑᵣᵢₐₗmin⁻¹ or more).

In some examples, the component separated from the fluid stream comprises H₂S.

In some examples, the fluid stream is selected from the group consisting of air, natural gas, byproducts of a chemical reaction, and post-combustion flue gas. In some examples, the fluid stream comprises air.

In some examples, the method comprises direct air capture.

Also disclosed herein are methods of use of any of the materials as described herein, for example in chemical separations of CO₂.

In some examples, the materials can be used in membranes, nanofluidic devices, or a combination thereof.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1—Single-Walled Zeolitic Nanotubes: Advantaged Supports for Poly(ethyleneimine) in CO₂ Separation from Simulated Air and Flue Gas

Abstract. Increasing levels of CO₂ necessitate improved methods of capturing this greenhouse gas to limit rising global temperatures. One promising way to lower levels is through capture and storage of CO₂. Prior research has demonstrated that amine polymers rich in primary and secondary amines supported on mesoporous substrates are effective, selective sorbent materials for removal of CO₂ from simulated flue gas and air. Common substrates used include mesoporous alumina and silica (such as SBA-15 and MCM-41). Conventional microporous materials are generally less effective, since the pores are too small to support non-volatile amines. Herein, newly discovered zeolite nanotubes, a first-of-their-kind quasi-1D hierarchical zeolite, are deployed as a substrate for poly(ethyleneimine) (PEI) for CO₂ capture from dilute feeds (FIG. 1). Poly(ethyleneimine) is impregnated into the zeolite at specific organic loadings. Thermogravimetric analysis (TGA) and porosity measurements are obtained to determine organic loading, pore filling, and surface area of the supported poly(ethyleneimine) prior to CO₂ capture studies. MCM-41 with comparable pore size and surface area is also impregnated with poly(ethyleneimine) to provide a benchmark material that allows for insight into the role of the zeolite nanotube intrawall micropores on CO₂ uptake rates and capacities. Over a range of poly(ethyleneimine) loadings, from 20 w/w %-70 w/w %, the zeolite allows for increased CO₂ capture capacity over the mesoporous silica by ˜25%. Additionally, uptake kinetics are roughly 4 times faster for nanotube supported poly(ethyleneimine) than a comparable poly(ethyleneimine)-impregnated in SBA-15. This new zeolite can offer numerous opportunities for engineering additional advantaged reaction and separation processes.

Introduction. As carbon dioxide (CO₂) levels continue to rise, the reduction of atmospheric CO₂ is necessary to limit the effects of climate change (Rogelj J et al. Nat. Clim. Chang. 2018, 8(4), 325-332). There are two main ways that post combustion CO₂ levels can be reduced. CO₂ capture at the source or production or direct air capture (DAC). Removal of CO₂ at the source of production (i.e., power plants, industrial plants) deals with flue gas where CO₂ concentrations are between 5-20% of total gaseous byproducts. This captured carbon is referred to as “avoided emissions”, and helps to limit the amount of CO₂ added but does not decrease existing levels. Direct air capture refers to the removal of CO₂ from ambient air.

One promising way to lower these levels is through the capture of CO₂ from the air (Haertel C J J et al. Chem 2021, 7(11), 2831-2834; Sanz-Pérez E S et al. Chem. Rev. 2016, 116(19), 11840-11876; Jones C W. Annu. Rev. Chem. Biomol. Eng. 2011, 2, 31-52). Technologies for CO₂ capture from air have existed since the 1940-50's (Blum H A et al. Ind. Eng. Chem. 1952, 44(12), 2969-2974; Tepe J B et al. Trans. Am. Inst. Chem. Eng. 1943, 39, 255-276) and have been commercially deployed in spacecraft and submarines. However, CO₂ removal from air was first connected with combatting climate change by Lackner in 1999 (Sanz-Pérez E S et al. Chem. Rev. 2016, 116(19), 11840-11876; Lackner K et al. Carbon Dioxide Extraction from Air: Is It An Option. In 24th Annual Technical Conference on Coal Utilization and Fuel Systems; 1999), and at such large scales, the technical approach may need to differ from small scale, vehicular applications noted above. CO₂ capture from the air- or direct air capture (DAC), as it is now called—can allow for “negative emissions” when coupled with geological storage. Negative emissions technologies (NETs) produce a fundamentally different product from CO₂ removal from point sources, which is a more mature technology area that produces “avoided emissions” (Negative Emissions Technologies and Reliable Sequestration: A Research Agenda; National Academies Press, 2019). In principle, direct air capture can be practiced at many locations, but in practice it requires suitable land, water, and (ideally renewable) energy. Furthermore, as a technology to be implemented outdoors and in all seasons, direct air capture must be compatible with varying weather conditions and is affected by many factors including temperature and humidity (Kong F et al. Korean J. Chem. Eng. 2022, 39(1), 1-19; Khatri R A et al. Energy & Fuels 2006, 20(4), 1514-1520).

Carbon dioxide capture is often carried out utilizing aqueous amines (Mumford K A et al. Front. Chem. Sci. Eng. 2015, 9(2), 125-141) or solid supported amines (Bollini P et al. J. Mater. Chem. 2011, 21(39), 15100-15120). While effective, aqueous amine solutions for CO₂ capture require significant energy for regeneration, and offer challenges of material corrosion and production of toxic byproducts (Dave N et al. Chem. Eng. Res. Des. 2011, 89(9), 1625-1638). Solid supported amines, which are less developed at the commercial scale, can potentially offer the advantage of lower energy costs and less equipment corrosion (Xu X et al. Energy & Fuels 2002, 16(6), 1463-1469; Choi S et al. ChemSusChem Chem. Sustain. Energy Mater. 2009, 2(9), 796-854). The performance of solid amine sorbents can be affected by a range of factors such as the sorbent composition, including how the amine is loaded onto the substrate (Didas S A et al. Acc. Chem. Res. 2015, 48(10), 2680-2687). In this regard, amine containing sorbents have been previously categorized into three classes. Class 1 sorbents are solid supports physically impregnated with amines (Xu X et al. Energy & Fuels 2002, 16(6), 1463-1469). Class 2 sorbents contain amines covalently bound to a substrate, typically via silane linkages (Harlick P J E et al. Ind. Eng. Chem. Res. 2006, 45(9), 3248-3255). Lastly, class 3 sorbents are made by polymerizing in situ to covalently bond the aminopolymer to the support (Hicks J C et al. J. Am. Chem. Soc. 2008, 130(10), 2902-2903). Each class has its benefits, with class 1 materials allowing for the easiest access to a wide array of amines, higher amine loadings, and ease of scalability (Sanz-Pérez E S et al. Chem. Rev. 2016, 116(19), 11840-11876; Xu X et al. Microporous Mesoporous Mater. 2003, 62(1-2), 29-45).

The design of the solid supported amine sorbents significantly affects carbon capture efficiency (Choi W et al. Chem. Eng. J. 2021, 408, 127289). The two primary constituents of sorbents for carbon capture are the amine(s) and the solid, which is typically a mesoporous, support. Any primary, secondary, or tertiary amine can be theoretically used as the chemical reaction between amine and CO₂ captures the CO₂. Poly(ethylenimine) (PEI) is the most commonly used amine and is a useful baseline oligomeric amine for use in any sorbent development project. Poly(ethylenimine) is made in a range of molecular weights and degrees of branching, is commercially available, and it yields high CO₂ sorption capacities while also being easily handled and stored (Sanz-Pérez E S et al. Chem. Rev. 2016, 116(19), 11840-11876; Choi S et al. ChemSusChem Chem. Sustain. Energy Mater. 2009, 2(9), 796-854; Drage T C et al. Microporous Mesoporous Mater. 2008, 116(1-3), 504-512; Li K et al. Appl. Energy 2014, 136, 750-755; Gelles T et al. Adsorption 2020, 26(1), 5-50). There are a number of different substrates that can be used for CO₂ capture including: polymers, oxides, activated carbons, metal organic frameworks, and zeolites (Choi S et al. ChemSusChem Chem. Sustain. Energy Mater. 2009, 2(9), 796-854; Hughes R et al. Energy and Fuels 2021, 35(7), 6040-6055; Lin J B et al. Science (80-.). 2021, 374(6574), 1464-1469; Li H et al. Green Chem. 2022, 24(4), 1545-1560; Zhang J et al. Process Saf Environ. Prot. 2022, 157, 390-396; Zhu X et al. Chem. Soc. Rev. 2022, 51, 6574-6651). Commonly used silica supports include highly ordered mesoporous substrates like SBA-15 and MCM-41 (Son W J et al. Microporous Mesoporous Mater. 2008, 113(1-3), 31-40). These well-defined porous materials aid scientific investigation, while more disordered, amorphous mesoporous oxides are typically deployed in practical applications at larger scales. High pore volume associated with ordered mesoporous materials allows for increased amine loading and thus greater CO₂ uptake capacities. In contrast, microporous materials such as zeolites are less frequently employed as supports for amines in carbon capture. Their microporous structure limits the size of the amine that can be used, with small amines being potentially too volatile for practical temperature swing adsorption cycles. Furthermore, the small micropores of zeolites can limit to loading of amines that can be achieved. Additionally, many zeolites are quite hydrophilic, limiting their utility for CO₂ capture at warm temperatures with high relative humidities, though low temperature applications may facilitate their use (Song M et al. Ind. Eng. Chem. Res. 2022, 61(36), 13624-13634; Fu D et al. Chem. Soc. Rev. 2022, 51, 9340-9370; Fu D et al. Proc. Natl. Acad. Sci. 2022, 119(39), e2211544119).

However, there are attractive features of zeolites, including their ordered, crystalline structures, and the ability to tune the particle size, shape, and morphology in many cases, with an array of lamellar or layered zeolites (2D) now complimenting their more well known, 3D counterparts. Recently, an example of a 1D zeolite, or zeolite nanotube, was discovered by Korde et al. (Korde A et al. Science (80-.). 2022, 375(6576), 62-66). These zeolite nanotubes are composed of a central, mesoporous channel of 2.5 nm in diameter bounded by microporous, crystalline zeolitic walls. Like the conventional 1D mesoporous substrates mentioned above (MCM-41, SBA-15, etc.), bundles of zeolite nanotubes possess similar mesoporous structures, while offering the potential added advantage of gas sorption through the zeolitic nanotube walls, instead of only in the mesopore openings at the end of each tube (or mesoporous silica particle, in the case of MCM-41 and SBA-15). Zeolite nanotubes may offer unique properties for applications in catalysis or adsorption, though no applications of these newly discovered materials have been reported to date.

Herein, the use of these newly reported quasi-1D hierarchical zeolite nanotubes are explored as a support for CO₂ capture after impregnation of the nanotubes (Korde A et al. Science (80-.). 2022, 375(6576), 62-66) with poly(ethylenimine). The zeolite nanotubes (ZN) are compared with common substrates for CO₂ capture that offer straight 1D mesopores, including SBA-15, MCM-41 with large pores (MCM-41-5.8), and MCM-41 with small pores (MCM-41-2.9). All supports were wet impregnated with poly(ethylenimine) (800 M_{w}) in differing loadings until a decrease in CO₂ uptake efficiency was observed, normally at ˜100% mesopore filling, as determined via N₂ physisorption data. The results demonstrate a noteworthy ˜25% increase in CO₂ capture capacity by the poly(ethylenimine) impregnated zeolite nanotubes over the mesoporous silicas. Further, uptake kinetics are over 4× faster than for poly(ethylenimine) impregnated mesoporous silica.

Results and Discussion. Composites of porous silicates and amines were synthesized via wet impregnation of poly(ethylenimine) utilizing four different substrates. All substrates were loaded with amines over a range of pore filling from 0-100% to evaluate the CO₂ sorption capacity, uptake rates, and amine efficiency (mol CO₂/mol N). The amine primarily used for this study was branched poly(ethylenimine) (PEI) with a molecular weight (M_{w}) of 800 g/mol. Poly(ethylenimine) was chosen due to its pervasive use in literature as well as high CO₂ uptake. Three mesoporous substrates were chosen to compare CO₂ sorption performance against poly(ethylenimine) impregnated zeolite nanotubes: SBA-15, MCM-41 with small mesopores, and MCM-41 with large mesopores. Of the three substrates, the most direct comparison to the zeolite nanotubes is small pore MCM-41 (MCM-41-2.9) with a mesopore diameter of 2.9 nm. A comparison to the zeolite nanotubes is closely comparable since the zeolite nanotubes have an inner channel diameter of 2.5 nm, but differ from MCM-41 in containing a microporous wall of ˜ 5-6 Å pore openings. The large pore MCM-41 (MCM-41-5.8) with pore size of 5.8 nm was chosen because this pore diameter is close to the pore size of the zeolite nanotubes as calculated form nitrogen sorption isotherm using the Barrett-Joyner-Halenda (BJH) method. Crystallographically, this pore size is close to the outer diameter of zeolite nanotubes. SBA-15 is one of the most widely used substrates for CO₂ capture with amines. SBA-15, which is perhaps the most studied support for poly(ethylenimine) in CO₂ capture experiments, was synthesized with a typical pore size of 6.6 nm, slightly larger than the observed zeolite nanotubes mesopore size. The surface areas of three of the four substrates are very similar: zeolite nanotubes at 1050 m²/g, MCM-41-2.9 at 1,230 m²/g, MCM-41-5.8 at 1,280 m²/g, with only SBA-15 at a lower value of 620 m²/g. As bare substrates, free of amines, zeolite nanotubes performed the best of all four materials in physisorption of CO₂ at 30° C. in the absence of added amines, with uptakes over 3× higher than for SBA-15 (Table 1), owing to the micropores of the zeolite nanotubes.

TABLE 1
Physical characteristics of four support materials loaded with poly(ethyl-
enimine) (PEI) and corresponding CO₂ uptake performance.

| | | | | CO₂ | |
|---|---|---|---|---|---|
| | | | | Capture at | Amine |
| | PEI | Pore | | 10% CO₂^{d} | Efficiency |
| | Loading^{a} | Volume^{b} | Pore | (mmol CO₂/ | (mol CO₂/ |
| Sorbent | (w/w%) | (cm³/g) | Filling^{c} | g sorbent) | mol N) |
| Zeolite | 0% | 1.50 | 0% | 0.36 | 0.00 |
| Nanotubes | 20% | 0.98 | 37% | 0.61 | 0.13 |
| | 30% | 0.71 | 54% | 1.34 | 0.20 |
| | 40% | 0.56 | 64% | 1.64 | 0.18 |
| | 50% | 0.34 | 78% | 1.84 | 0.16 |
| | 60% | 0.12 | 92% | 1.94 | 0.14 |
| | 65% | 0.05 | 97% | 2.23 | 0.15 |
| | 70% | 0.00 | 100% | 2.09 | 0.13 |
| SBA-15 | 0% | 0.97 | 0% | 0.10 | 0.00 |
| | 10% | 0.63 | 35% | 0.31 | 0.13 |
| | 30% | 0.24 | 75% | 0.49 | 0.07 |
| | 40% | 0.13 | 87% | 1.08 | 0.12 |
| | 50% | 0.03 | 97% | 1.30 | 0.12 |
| | 60% | 0.00 | 100% | 1.80 | 0.13 |
| MCM-41- | 0% | 0.90 | 0% | 0.01 | 0.00 |
| 2.9 | 10% | 0.56 | 38% | 0.24 | 0.11 |
| | 12% | 0.47 | 48% | 0.29 | 0.11 |
| | 15% | 0.31 | 65% | 0.40 | 0.12 |
| | 18% | 0.24 | 73% | 0.45 | 0.11 |
| | 20% | 0.21 | 77% | 0.54 | 0.12 |
| | 30% | 0.018 | 98% | 0.10 | 0.01 |
| | 40% | 0.00 | 100% | 0.03 | 0.00 |
| MCM-41- | 0% | 2.23 | 0% | 0.05 | 0.00 |
| 5.8 | 20% | 0.77 | 65% | 0.79 | 0.18 |
| | 40% | 0.39 | 83% | 1.74 | 0.19 |
| | 50% | 0.12 | 95% | 1.49 | 0.13 |
| | 60% | 0.01 | 100% | 1.52 | 0.11 |

^{a}Organic loading calculated by burn off studies via thermogravimetric analysis (TGA) under inert conditions.
^{b}Pore volume and width were obtained via N₂ physisorption experiments. Zeolite nanotubes have a pore volume of 1.54 cm³/g and a pore width of 6.2 nm. SBA-15 has a pore volume of 0.97 cm³/g and a pore size of 6.6 nm. MCM-41 small pore has a pore volume of 0.90 cm³/g and a pore size of 2.9 nm. MCM-41 large pore has a pore volume of 2.23 cm³/g and a pore size of 5.8 nm.
^{c}Pore filling is obtained by comparing initial Pore volume with pore volume after amine impregnation.
^{d}CO₂ capture pseudo-equilibrium obtained via thermogravimetric analysis with a gas flow of 10% CO₂ in He at 30° C. for 3 h.

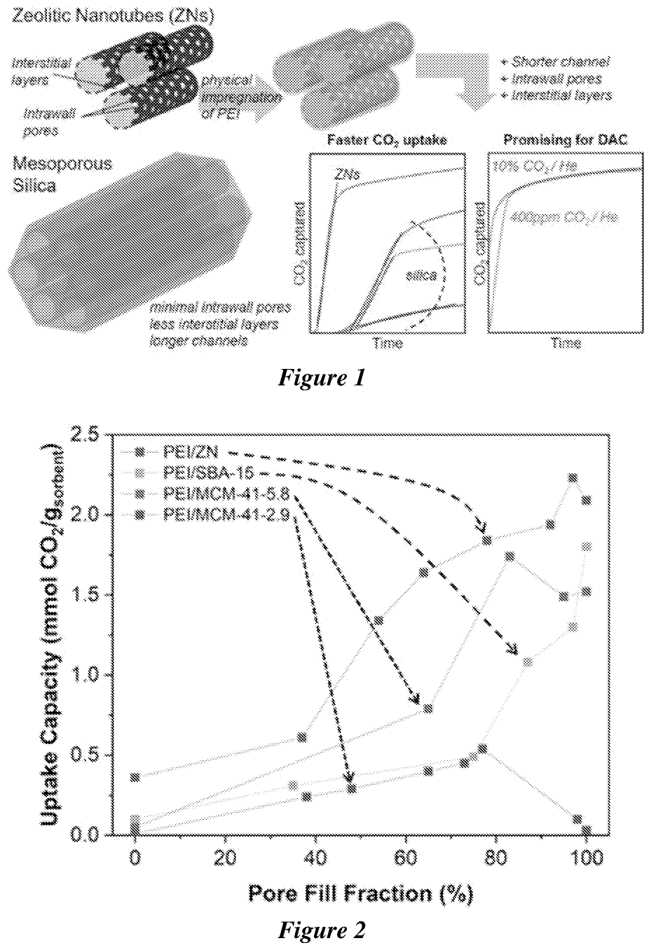

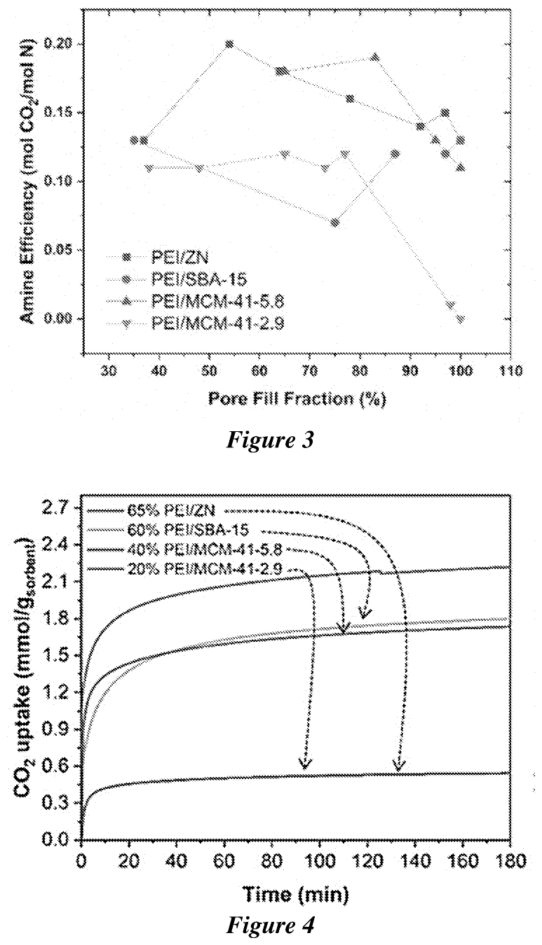

CO₂ sorption experiments were performed on a thermogravimetric analyzer (TGA) under a flow of 10% CO₂ in He at 30° C. Samples were dried under inert gas for 1 h at 100° C. prior to an exposure to CO₂ for 3 h. Uptake is calculated in mmol of CO₂ per dry mass of the sorbent (mmol CO₂/g sorbent). As shown in Table 1 and FIG. 2, the CO₂ uptake capacity does not scale with pore filling. Perhaps, for the composites having a limited amount of poly(ethylenimine) (i.e., lower pore filling), the poly(ethylenimine) chains were strongly bound to the pore walls, limiting the availability of amines for CO₂ sorption. Increasing poly(ethylenimine) loadings and thus pore filling can augment the number of accessible amine sites, leading to higher CO₂ uptake capacities. However, filling too much pore volume may limit mass transfer of CO₂, as shown in MCM-41-2.9 and MCM-41-5.8, causing a decrease in uptake capacities during the limited time of exposure to CO₂ gas (Table 1). Such trends of uptake capacities versus pore fill fraction can be better understood by analyzing trends of amine efficiencies (mol CO₂/mol N). Sorbents studied herein generally showed volcano shaped curves of amine efficiencies versus poly(ethylenimine) loadings (FIG. 3). Such a volcano-type relationship can be understood when considering that CO₂ capture happens through diffusion and reaction of CO₂ along the amine-packed phase, and excess poly(ethylenimine) limits access to all amine sites in the period of sorption (Wang X et al. Microporous Mesoporous Mater. 2013, 169, 103-111; Sujan A R et al. ACS Appl. Polym. Mater. 2019, 1(11), 3137-3147; Han Y et al. Chem. Eng. J. 2015, 259, 653-662; Kwon H T et al. Chem. Mater. 2019, 31(14), 5229-5237; Holewinski A et al. J. Am. Chem. Soc. 2015, 137(36), 11749-11759).

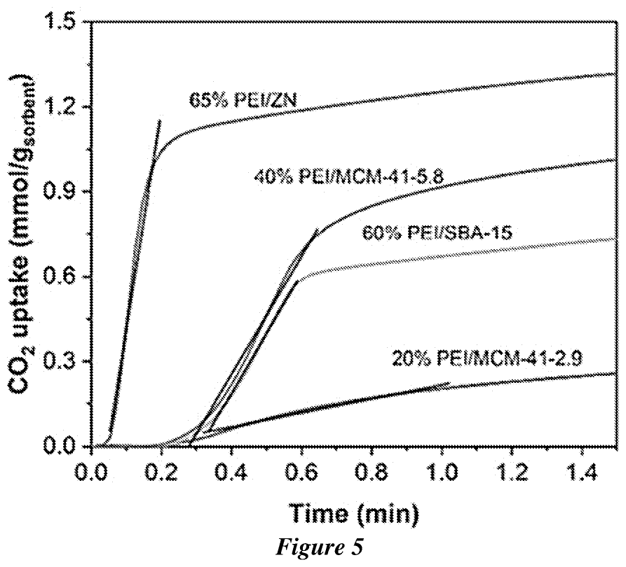

Comparing the CO₂ uptake capacities, zeolite nanotubes at 65% poly(ethylenimine) loading captured 2.23 mmol CO₂/g sorbent, with the next best sorbent, SBA-15, at 60% poly(ethylenimine) loading, capturing 1.8 mmol CO₂/g sorbent. Higher amine loadings were attempted for SBA-15, as no capacity decrease was observed as pore filling approached 100%; however above 60% poly(ethylenimine) loading, samples were too viscous and sticky to handle efficiently as they were well over 100% pore filling. Indeed, some TEM images show evidence of thick poly(ethylenimine) layers on the outer surfaces of SBA-15 after complete pore filling is achieved. The two MCM-41 sorbents performed more poorly, with the MCM-41-2.9 at 20% poly(ethylenimine) loading only capturing 0.54 mmol CO₂/g sorbent and the MCM-41-5.8 at 40% poly(ethylenimine) loading capturing 1.74 mmol CO₂/g sorbent. Chosen as the direct comparison based on mesopore size, MCM-41-2.9 had significantly lower CO₂ uptake than the zeolite nanotube-65% poly(ethylenimine) (ZN-65% PEI), with 76% less CO₂ captured. Upon examining the uptake curves of these four sorbents with optimal poly(ethylenimine) loadings for each support, not only is the total amount of CO₂ captured higher for the zeolite nanotubes, but the rate of uptake is faster as well. Uptake curves shown in FIG. 4-FIG. 5 allow for a more direct comparison between different supports with their corresponding best poly(ethylenimine) loadings (from a sorption capacity perspective) for each sorbent. ZN-65% PEI has the fastest uptake rate, followed by SBA-15, MCM-41-5.8, and MCM-41-2.9, in order.

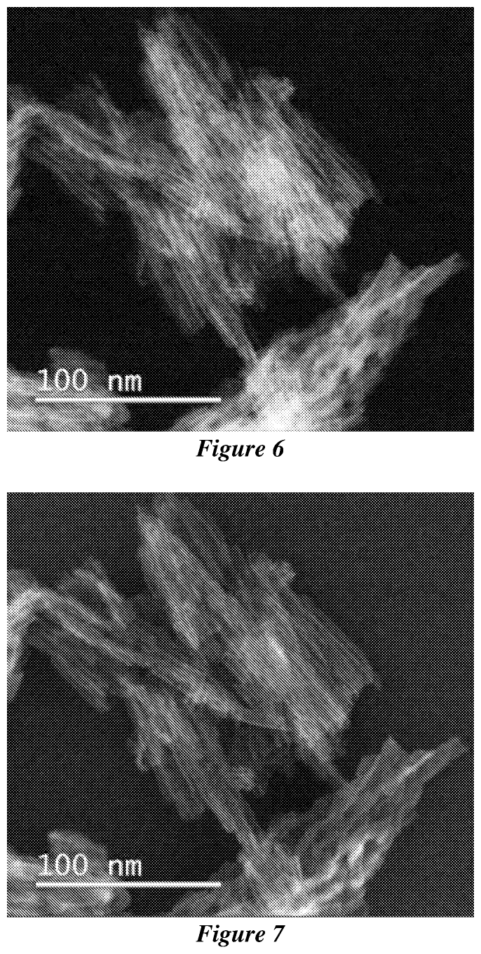

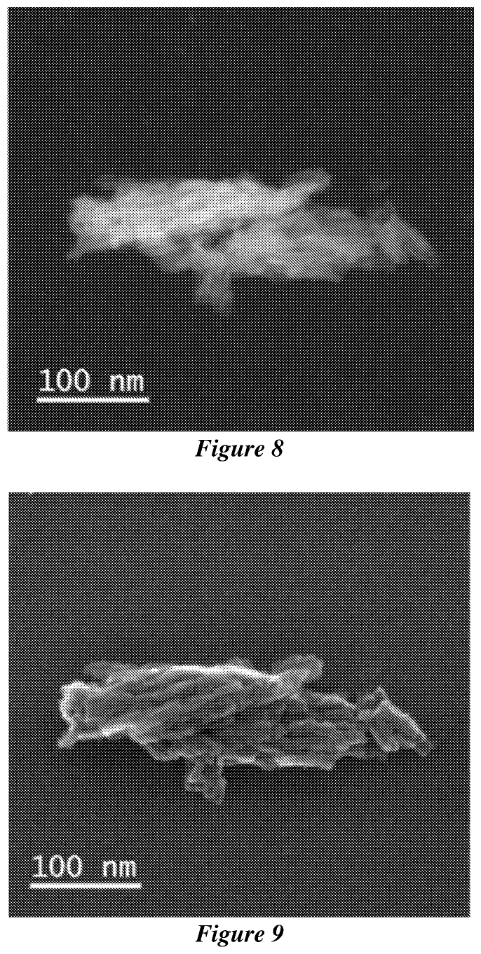

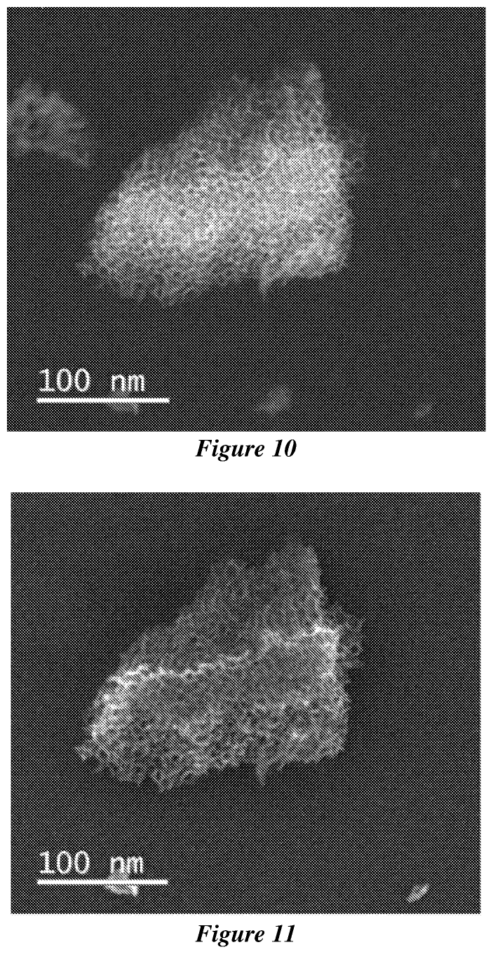

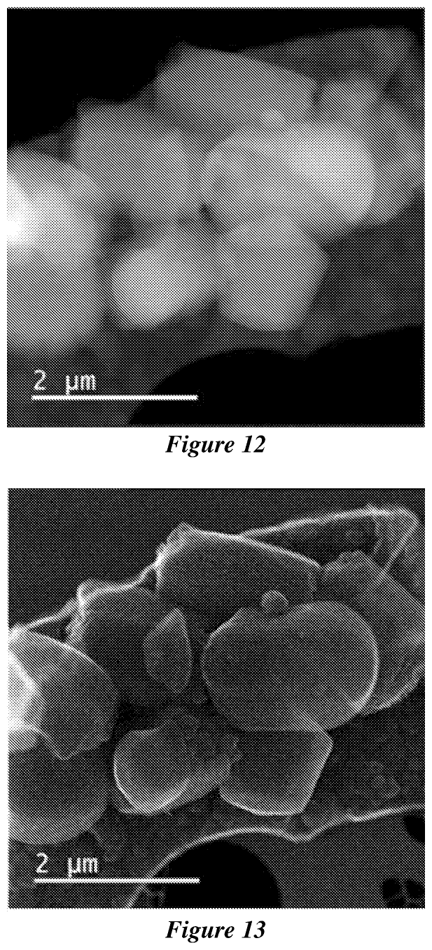

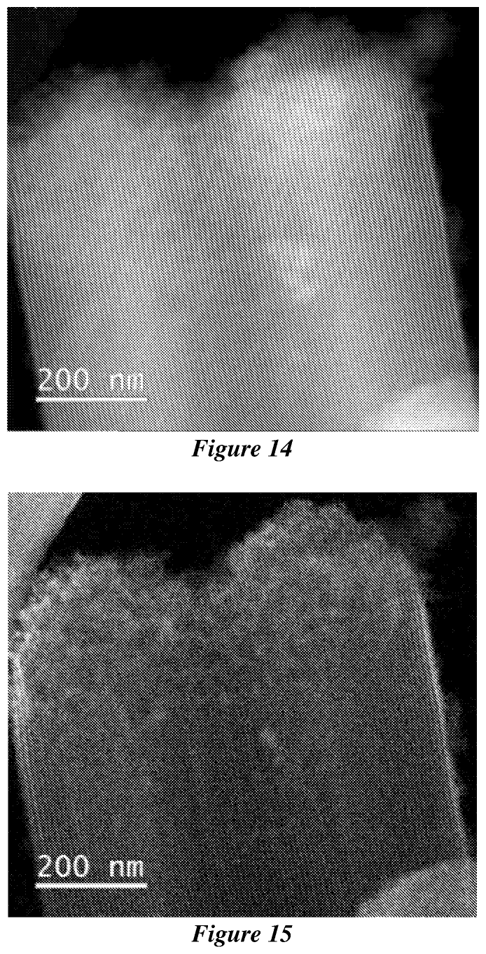

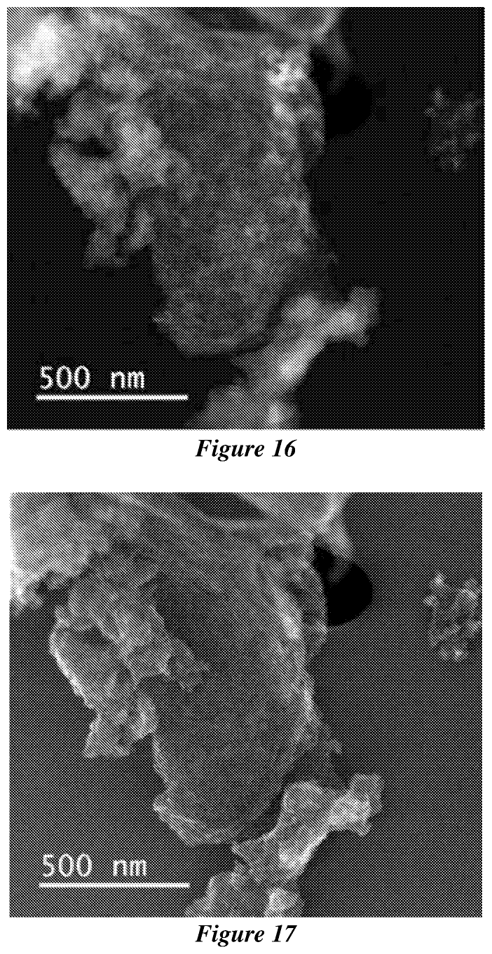

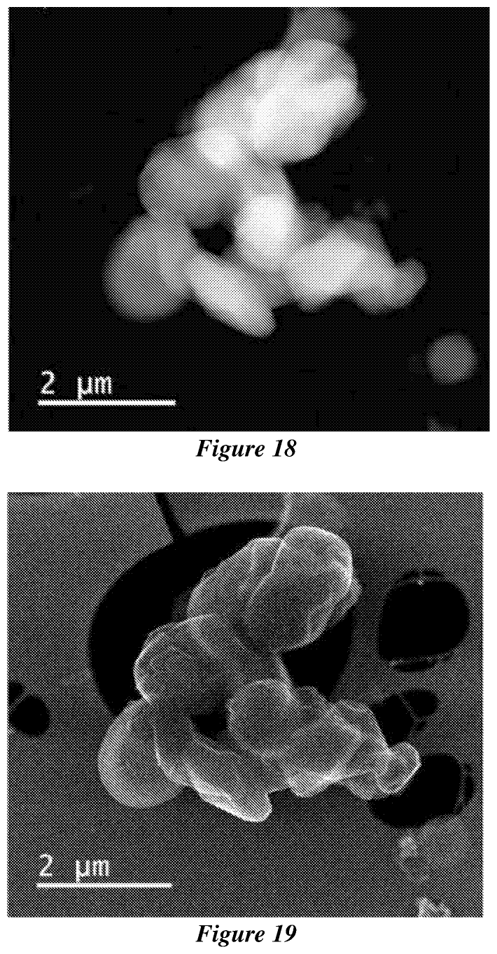

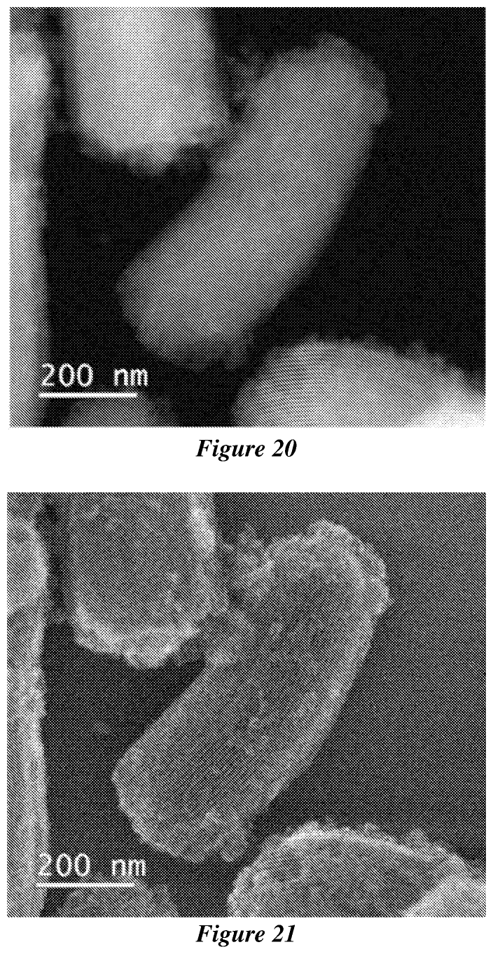

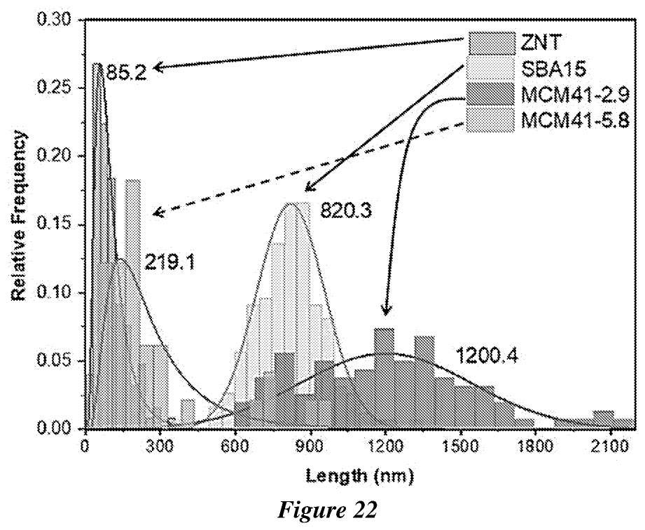

FIG. 5 also highlights the initial uptake rates during the first 1.5 minutes; taking the slope of these initial curves gives the rate of uptake. ZN-65% PEI has a significantly faster rate of uptake than either of the other three sorbents at 6.2 mmol CO₂ g⁻¹_{sorbent} min⁻¹ compared to SBA-15 at 1.66, MCM-41-2.9 at 0.26 and MCM-41-5.8 at 1.9 (same units: mmol CO₂ g⁻¹ sorbent min⁻¹). ZN-65% PEI has a 24× faster uptake rate than its direct comparison, MCM-41-2.9, and over 3× faster uptake rate than SBA-15. These faster uptake rates can directly result in shorter CO₂ capture cycles, therefore allowing for more CO₂ capture per day if applied on a larger scale. The three poly(ethylenimine) impregnated mesoporous silica sorbents, MCM-41-2.9, MCM-41-5.8, SBA-15, show a short latency or induction period before CO₂ starts being captured that is not present in the zeolite nanotube sorbent. It is hypothesized that the lack of such an induction period for nanotubes can be ascribed to the small apertures (micropores) along the channels of the nanotubes, promoting mass transfer of CO₂. This becomes more apparent when amine efficiencies of the sorbents having similar pore fill fraction (thus similar extent of free volume) are compared, where zeolite nanotube-based sorbents generally showed higher amine efficiencies than other sorbents. In addition to the presence of small apertures, referring to FIG. 6-FIG. 22, the zeolite nanotubes have a shorter average path length (or particle length) compared to other sorbents, which can promote rates of mass transfer and CO₂ sorption, mitigating the latency during uptake and promoting sorption. Trends of the uptake rates can also be reconciled considering channel lengths of the supports, as shorter channels may reduce diffusion resistance which leads to faster CO₂ uptake rates (Heydari-Gorji A et al. Energy & Fuels 2011, 25(9), 4206-4210). As shown in FIG. 22, zeolite nanotubes showed shorter lengths (˜85 nm) while MCM-41-2.9 (tubular shape, as shown in FIG. 10-FIG. 21) and SBA-15 (pill shape, FIG. 10-FIG. 21), which contain regular arrays of mesopores, had much longer channel lengths (MCM-41-2.9: 1.2 μm, SBA-15: 0.8 μm). MCM-41-5.8, as shown in FIG. 10-FIG. 21, lost its spherical morphology likely due to the addition of decane, which was as a swelling agent used to increase the pore size. The average length of many particles appeared shorter than MCM-41-2.9 and SBA-15 (FIG. 22), but still longer than that of the zeolite nanotubes. One interesting comparison can be made by comparing 65% PEI/ZN and 40% PEI/MCM-41-5.8, whose BJH pore sizes and average particle lengths were comparable (FIG. 22). The 40% PEI/MCM-41-5.8 material showed much higher remaining pore volume compared to that of 65% PEI/ZN (Table 1), which should facilitate more rapid CO₂ uptake. However, 65% PEI/ZN showed much faster uptake compared to the 40% PEI/MCM-41-5.8. It is hypothesized that the faster CO₂ uptake rates of the PEI/ZN materials are derived from (i) the straight crystalline mesopore (vs. the more tortuous channels in PEI/MCM-41-5.8 (FIG. 6-FIG. 9 vs. FIG. 22), (ii) the existence of micropores distributed along the walls of the nanotubes, and (iii) the marginally shorter average channel length.

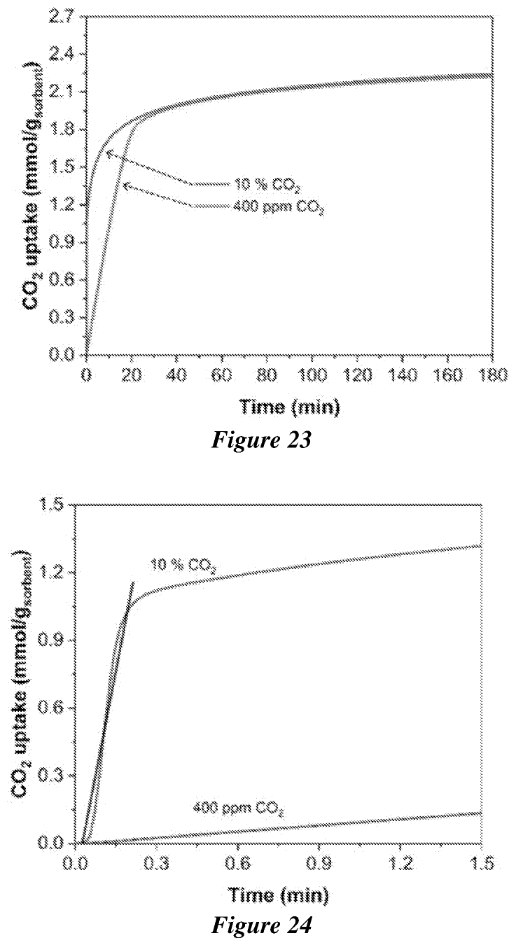

In an interesting observation, the pseudo-equilibrium CO₂ capacity does not change when comparing the uptake of the zeolite nanotubes at 65% poly(ethylenimine) loading at two different CO₂ concentrations, 10% and 400 ppm (0.04%). Normally, CO₂ capacities are strongly influenced by the driving force for adsorption, with smaller sorption capacities at lower CO₂ concentrations. The observation of equivalent CO₂ uptakes at 0.04% and 10% CO₂ has only been previously observed once before (Kwon H T et al. Chem. Mater. 2019, 31(14), 5229-5237). FIG. 23-FIG. 24 shows a comparison between the uptake of the zeolite nanotubes at the two different CO₂ concentrations over a normal 3 h period of CO₂ sorption. At 400 ppm CO₂, the rate of uptake is an order of magnitude lower, with the uptake rate using 10% CO₂ of ZN-65% PEI at 6.2 mmol CO₂ g⁻¹ sorbent/min while the uptake in 400 ppm CO₂ is only 0.1 mmol CO₂ g⁻¹_{sorbent}min⁻¹. Even with this slower sorption rate, the final CO₂ capture in both CO₂ concentrations remains the same at ˜2.2 mmol CO₂/g sorbent. Previously when such behavior was observed it was hypothesized that rapid CO₂ sorption at 10% CO₂ conditions led to rapid crosslinking of poly(ethylenimine) chains and lowered the free volume around the easily accessible amines, erecting a diffusive barrier for further sorption (Korde A et al. Science (80-.). 2022, 375(6576), 62-66). On the other hand, for 400 ppm CO₂, slower CO₂ sorption may prevent rapid polymer crosslinking, keeping more of the amines accessible for CO₂ capture, eventually leading to comparable amine efficiencies at the pseudo-equilibrium conditions. The high uptake rate here for the zeolite nanotube sorbent may lead to a similar observation.

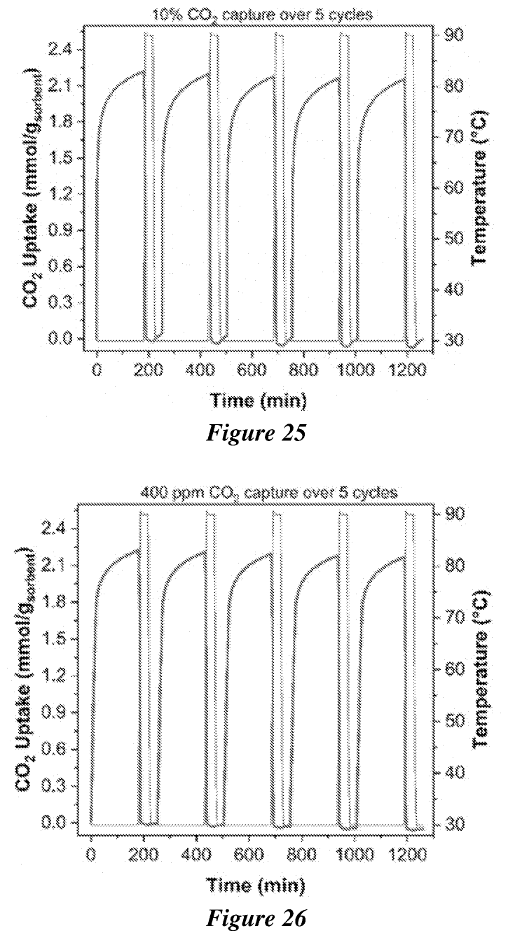

Multiple temperature swing sorption cycles were run using both 400 ppm and 10% CO₂ to determine the retained capture efficiency of the amine impregnated zeolite nanotubes over multiple uses. Cycles were run similarly to previous experiments after an initial pretreatment (100° C.). Samples were exposed to 3 h CO₂ capture, followed by desorption at 90° C. in flowing inert gas, 30 min isothermal at 30° C. in inert, and the cycle was repeated five times. The capture period in the thermogravimetric analyzer is longer than expected under optimized conditions in a practical contactor such as a fiber (Sujan A R et al. ACS Sustain. Chem. Eng. 2019, 7(5), 5264-5273) or monolith (Sinha A et al. Ind. Eng. Chem. Res. 2017, 56(3), 750-764; Sakwa-Novak M A et al. ChemSusChem 2016, 9(14), 1859-1868) due to the unique, non-ideal flow patterns in the thermogravimetric analyzer. FIG. 25-FIG. 26 shows the normalized traces of the ZN-65% PEI at both 400 ppm CO₂ and 10% CO₂. At both concentrations of CO₂, the sample preserves similar sorption performance over all five cycles. Both samples show a slight decrease in their baseline as some volatiles such as water or low molecular weight amines are removed during the desorption steps.

The working temperature is important for a CO₂ sorbent to be robust. With the average temperature of the planet being under 30° C., subambient (below room temperature) CO₂ sorption testing is necessary to determine the effectiveness of new sorbents over a range of temperatures if the sorbent is to be considered for direct air capture applications (Kong F et al. Korean J. Chem. Eng. 2022, 39(1), 1-19; Rim G et al. JACS Au 2022, 2(2), 380-393). ZN-65% PEI was tested at temperatures between 0° C. to 30° C. with 400 ppm CO₂ to determine its efficacy under subambient conditions. CO₂ sorption at lower temperatures should lead to a decrease in sorption rate, but could lead either to an increase or decrease in CO₂ uptake (Rim G et al. JACS Au 2022, 2(2), 380-393). If mass transfer is a dominant factor, for example through polymer-filled pores, one may expect reduced uptake at low temperatures at a fixed uptake time. In contrast, if sorption equilibria can be approached quickly enough, CO₂ uptake should increase due to thermodynamics. CO₂ uptake capacity increased from 30° C. to 15° C. (˜1.6 to 1.25 mmol/g), and then decreased as temperature was reduced, reaching ˜0.8 mmol/g at 0° C. It is hypothesized that poly(ethylenimine) chains retained their mobilities at 15° C. so that the rate of CO₂ diffusion appeared sufficiently fast to take advantage of the thermodynamic advantage of lower temperature conditions. However, further decreasing the uptake temperatures yielded lower uptake capacities, likely due to significantly lowered poly(ethylenimine) mobilities and thus slower CO₂ diffusion.

Along with temperature, humidity can also play a large role in CO₂ sorption. In dry conditions, to achieve high uptakes (Bollini P et al. J. Mater. Chem. 2011, 21(39), 15100-15120; Bacsik Z et al. Langmuir 2011, 27(17), 11118-11128; Zhang H et al. Langmuir 2020, 36(46), 14104-14112), two amines are needed to form carbamate linkages, as one amine reacts with CO₂ and a second amine is necessary to stabilize the charge generated. Amine sorbents often show increased efficiency in the presence of humidity, as a new sorption pathway becomes available where only one amine reacts with water and CO₂ to form bicarbonate species (Chen C H et al. J. Am. Chem. Soc. 2018, 140(28), 8648-8651). Using a thermogravimetric analyzer capable of applying a humid stream, CO₂ capture with ZN-65% PEI was studied at 400 ppm in relative humidities between 0-37.5% at 30° C.

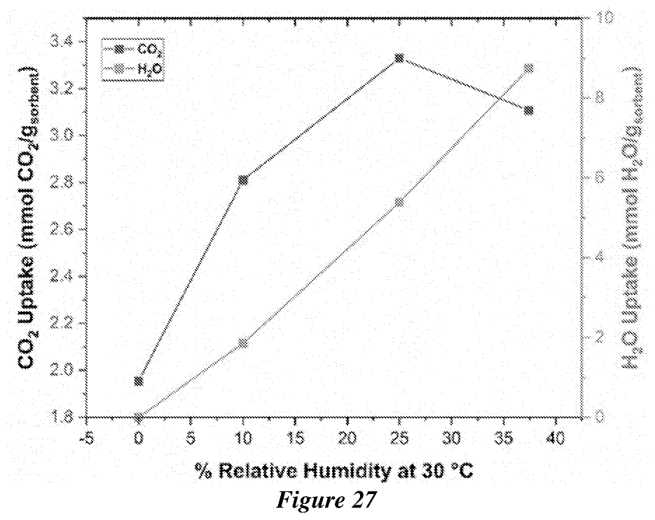

As shown in FIG. 27, under the humidity range explored (0-37.4%), the sorbents showed enhanced uptake capacities up to a certain level of humidity but decay in uptake at the higher limit (37.5%), while the H₂O uptake steadily increased with increasing humidity. The dry CO₂ capacity measured using the humid thermogravimetric analysis gave an uptake of 1.95 mmol CO₂/g sorbent, which is about 13% lower than what was measured with the thermogravimetric analysis without a humid stream (2.23 mmol CO₂/g sorbent, as shown in FIG. 4-FIG. 5). It is suspected that this difference comes from a slightly lower concentration of CO₂ in the inlet gas in this second thermogravimetric analyzer instrument. Exposed to a humid gas flow, the sorbent exhibited an initial increase in uptake (up to 25% relative humidity) followed by a drop as the relative humidity further increased (37.4%). At 10% and 25% relative humidity, uptakes of 2.81 and 3.33 mmol CO₂/g sorbent were observed, which accounted for an increase of 44% and 71% over the dry sample, respectively. When raising the relative humidity to 37.4%, there was a 28% decrease in efficiency when compared to the dry sample.

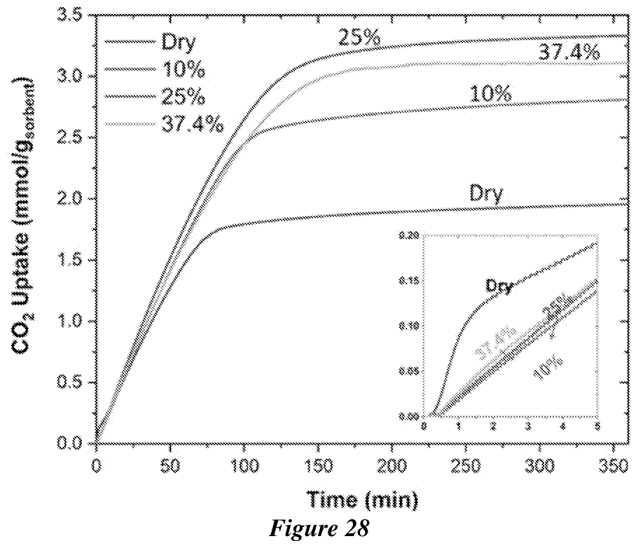

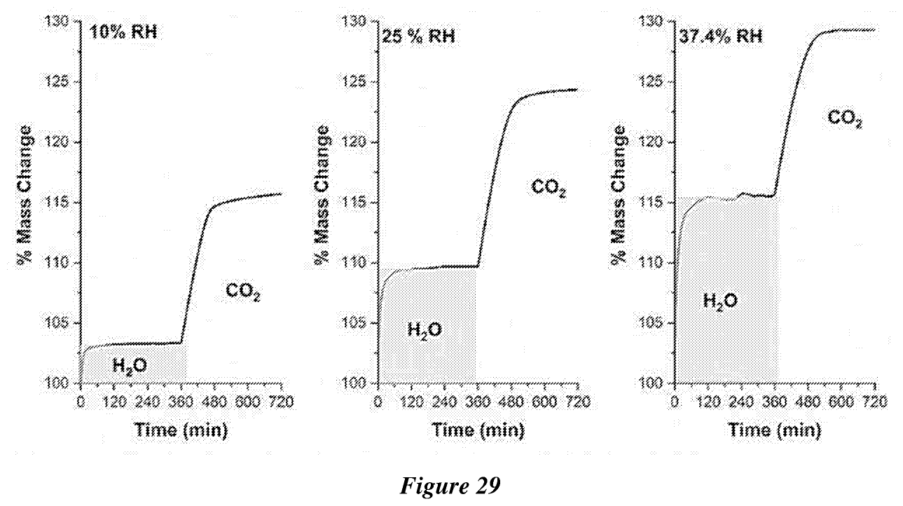

It is hypothesized that having adsorbed H₂O can lubricate chain motions of poly(ethylenimine) (Bermejo J S et al. J. Chem. Phys. 2008, 129(15), 154907; Luo S et al. J. Appl. Polym. Sci. 2002, 85(1), 1-8) while promoting formation of bicarbonate species (Chen C H et al. J. Am. Chem. Soc. 2018, 140(28), 8648-8651). However, sorption of too much water may leave too little free volume, reducing the uptake performance by slower diffusion of CO₂. This hypothesis can be supported by analyzing the uptake rates. Interestingly, the dry CO₂ case showed a surge of uptake followed by a shallow increase, while the humid CO₂ cases showed short induction times followed by consistent mass gain (FIG. 28, inset). For the dry CO₂ case, the first rapid increase (up to ˜1.5 min) shown in the dry CO₂ case can be attributed to CO₂ sorption to highly accessible amines within relatively large free volume, and the following gradual increase (up to ˜70 min) can be ascribed to penetration of CO₂ through a mobile poly(ethylenimine) phase. Lastly, the very slow mass gain (˜70 min and thereafter) can be related to slow CO₂ diffusion along relatively less mobile poly(ethylenimine) domains. Interestingly, the wet CO₂ cases lack the first stage where rapid mass gain was observed in the case of dry conditions. Perhaps the absence of such a rapid mass gain for the wet CO₂ cases comes from occluded free volume from adsorbed water. However, except for the early stage of CO₂ uptake, the wet CO₂ cases showed consistently higher uptake rates over extended times (FIG. 28, inset) compared to the dry CO₂ case. The uptake rates in the time range from 2 to 5 min were analyzed and it was confirmed that the wet streams yielded faster uptake rates (Table 2). Moreover, higher humidity levels (e.g., 25, 37.4%) resulted in extended times for the second uptake regime (i.e., CO₂ diffusion through mobile poly(ethylenimine) phase), as shown in FIG. 28. All humid CO₂ uptake curves are given in FIG. 29.

TABLE 2
Summary of humid CO₂ uptake under varied relative humidity at fixed
CO₂ concentration (400 ppm CO₂, 30° C.).

| Relative | Uptake capacity | Uptake rate (from ~2-5 min) |
|---|---|---|
| humidity (%) | (mmol CO₂/g sorbent) | (mmol CO₂ kg⁻¹_{sorbent} min⁻¹) |
| 0 | 1.95 | 0.019 |
| 10 | 2.81 | 0.030 |
| 25 | 3.33 | 0.032 |
| 37.4 | 3.11 | 0.030 |

Managing competitive H₂O and CO₂ sorption in PEI/ZN sorbents can be important for their potential practical use for CO₂ capture. Sayari and coworkers reported that pore-expanded MCM-41 supports lined with hydrophobic alkyl chains were robust CO₂ sorbents when impregnated with poly(ethylenimine) (Heydari-Gorji A et al. Langmuir 2011, 27(20), 12411-12416; Sayari A et al. ChemSusChem 2016, 9(19), 2796-2803). Such materials exhibited significantly higher CO₂ uptake, consistently high uptake under a broad range of humidity, and maintained their performance after multiple CO₂ sorption-desorption cycles compared to similar materials with hydrophobic additives. This points toward potentially leaving some of the zeolite structure-directing agent within the nanotube materials prior to poly(ethylenimine) impregnation, or use of other hydrophobic additives to tune the hydrophilic/hydrophobic balance of the materials, broadening the range of conditions for practical CO₂ capture.

Conclusions. In the work, newly discovered zeolite nanotubes were used as a substrate for oligomeric poly(ethylenimine) to create sorbents for CO₂ sorption from simulated flue gas or air. The zeolite nanotubes provided both elevated CO₂ capacities and faster uptake kinetics when compared against commonly used mesoporous silica substrates, including mesoporous MCM-41-2.9, with similar mesopore size to the zeolite nanotubes. Under simulated direct air capture conditions, in comparison with MCM-41-2.9, ZN-65% PEI captured four times more CO₂ with an uptake rate an order of magnitude faster. When compared to SBA-15 60% PEI, a benchmark material that is well-studied in the literature, ZN-65% PEI captured ˜25% more carbon with four-fold faster uptake. The improved update capacity and kinetics can be ascribed to the improved access to the mesopores through the zeolitic, microporous walls of the nanotube as well as the short nanotube lengths relative to the size of the mesoporous silica particles. Interestingly, the maximum CO₂ uptake for ZN-65% PEI is identical (˜2.2 mmol CO₂/g sorbent) under two different CO₂ concentrations, 400 ppm and 10% CO₂, showing promise for use under ambient direct air capture conditions. Over multiple temperature swing cycles, the performance of ZN-65% PEI did not decrease using either concentration of CO₂; however, uptake rates at 10% CO₂ were 60-times faster than at 400 ppm CO₂. The CO₂ uptake of ZN-65% PEI increases up to intermediate relative humidity (in this paper, up to 25%) and then decreases as humidity goes higher. Competitive binding to water, less free pore volume due to adsorbed water, and changes in zeolite structure/stability under humid conditions may contribute to this trend.

Herein, only a certain range of conditions were explored (temperature, humidity, P_{CO2}, etc.). However, these results show that ZN-65% PEI outperforms common, benchmark poly(ethylenimine)-loaded mesoporous silica sorbents, exhibits stability over multiple cycles under both 10% and 400 ppm CO₂ concentrations, and performs well in moderate humidities up to 35%, the maximum tested herein.

This work represents the first application of newly discovered zeolite nanotubes, and the work demonstrates that advantaged sorption and diffusion might be obtained relative to more traditional supports, such as non-crystalline mesoporous silicas and crystalline 2D or 3D zeolites.

Materials and Methods

All chemicals reported were obtained from Sigma-Aldrich, TCI America, or Alfa Aesar and used without further purification. Helium (UHP), nitrogen (UHP), 400 ppm CO₂/He, 10% CO₂/He were obtained from Airgas.

Nitrogen (N₂) Physisorption. N₂ physisorption was performed on a Micromeritics Tristar II 3020 at 77 K using 100 mg of sorbent. Samples were degassed under vacuum at 100° C. for 10 h prior to measurements. All pore volumes were determined using the Barrett-Joyner-Halenda (BJH) method.

XRD. All XRD patterns were obtained with powdered samples on a PANalytical X'Pert Pro MPD diffractometer with CuK_{α} radiation (45 kV, 40 mA).

SEM and TEM. Scanning Transmission Electron (STEM) and Scanning Electron (SEM) images were obtained on an aberration-corrected Hitachi 2700 electron microscope operating at 200 kV. The samples were prepared by sonicating bare and poly(ethylenimine)-impregnated adsorbents in acetone for 3 minutes, and then adding few drops of the dispersion onto a holey carbon Cu-coated grids.

Thermogravimetric analyses (TGA). Thermogravimetric analysis for organic mass loss calculation were carried out on a Netzsch (STA 449 F3 Jupiter). Samples were run from room temperature to 700° C. at a ramp rate of 10° C./min. Thermogravimetric analysis for CO₂ capture under dry CO₂ balance He were carried out on a TA-Instruments (Q500) TGA. CO₂ sorption under humid CO₂ streams (CO₂, H₂O, N₂) was monitored using TA-Instrument (Q500) TGA equipped with a LI-COR dew point generator (LI-610) to generate a humid N₂ stream, which was mixed with a CO₂/N₂ stream. Lastly, CO₂ capture at the temperature below room temperature was examined using NETZSCH TGA (STA 449 F3 Jupiter) with a gas stream passing through liquid N₂ for bringing the temperature lower than 30° C.

CO₂ Capture experiments. CO₂ capture was carried out using a previously reported method. 10 mg±1 mg of sorbent was added to the platinum pan. To evaporate any adsorbed volatiles, the sorbent was initially heated under inert He to 100° C. at a rate of 10° C./min and then held at 100° C. for 1 h. The sample was then cooled to 30° C. at a rate of 10° C./min and held for 5 min. The gas was then changed to either 10% CO₂ (balanced He) or 400 ppm (balanced He) and held for 3 h at 30° C. for CO₂ adsorption. Then, the sample was then heated to 100° C. at 10° C./min and held for 1 h to degas the captured CO₂. The materials CO₂ sorption efficiency is defined as moles of CO₂ adsorbed over grams of sorbent. The mass gained during the CO₂ adsorption cycle yields the total amount of CO₂ adsorbed. Humid CO₂ sorption measurements employed a similar thermogravimetric analyzer but connected to a humid N₂ stream. Sorbents were pre-saturated with adsorbed H₂O under a desired relative humidity at 30° C. and then the humid CO₂ stream was passed over the sorbent and the CO₂ sorption was gravimetrically measured. CO₂ sorption under subambient temperatures was examined using a similar temperature program except with the temperature of CO₂ capture being varied. Approximately 20 mg of sample was used in case of subambient capture to minimize noise resulting from buoyancy effects brought on by the periodic flow of the liquid nitrogen cooling stream.

Synthesis of SBA-15. The synthesis of SBA-15 was carried out using a previously published procedure. In a 2 L flask, 24.0 g of Pluronic P-123 block copolymer ((EO)₂₀(PO)₇₀(EO)₂₀) was added and then dissolved with 636 g of deionized water and 120 mL of 12.1 M HCl. The solution was stirred form a minimum of 3 h or until all P-123 was dissolved. Once fully dissolved, 46.6 ml of tetraethylorthosilane (TEOS) was added dropwise to the reaction and then stirred at 40° C. for 20 h. During this time, a white precipitate formed. The reaction was then heated to 100° C. for 24 h while not stirring. 400 mL of deionized water was added to quench the reaction. Then, the resulting white precipitate was filtered and washed with copious amounts of deionized water. The white solid was dried in an oven at 75° C. for 12 h and then calcined with the following procedure: heat to 200° C. at 1.2° C./min, hold at 200° C. for 1 h, heat to 550° C. at 1.2° C./min, hold at 550° C. for 12 h, cool to room temperature. Resulting white powder was stored under ambient lab conditions.

Synthesis of MCM-41 large pore. The synthesis of MCM-41 large pore (MCM-41 LP) was synthesized following a modified published procedure. First, 2.5 g of cetyltrimethylammonium bromide was dissolved in 12.24 mL of deionized water in a 100 mL round bottom flask stirring at 40° C. 1.89 g of decane were added and the solution was stirred until homogenized. Next, 0.25 g of sodium silicate were added dropwise. Th pH of the gel was adjusted with sulfuric acid to 10.0. After stirring for 30 min, the gel was sealed in a Teflon autoclave and heated at 100° C. for 8 days. Resulting white powder was stored under ambient lab conditions.

Synthesis of MCM-41 small pore. The synthesis of MCM-41 small pore (MCM-41 SP) was synthesized following published procedure. First, 2.77 g of cetyltrimethylammonium bromide was dissolved in 121 mL of deionized water in a 250 mL round bottom flask. 8.5 g of an aqueous ammonia solution (28 wt. % NH₄OH) was then added and stirred at room temperature. Once dissolved, 10 g of tetraethylorthosilane was added dropwise to the solution and then stirred for 2 h. The resultant solid was filtered and washed multiple times with deionized water and then dried in an oven at 75° C. Next, the solid was calcined under the following conditions: ramp to 550° C. at 1.2° C./min, hold at 550° C. for 12 h, then cooled to room temperature at 10° C./min. Resulting white powder was stored under ambient lab conditions.

Synthesis of structure directing agent (SDA) (BCPh10Qui) 1,1′-(([1,1′-biphenyl]-4,4′-diylbis(oxy))bis(decane-10,1-diyl))bis(quinuclidin-1-ium) bromide. The SDA BCPH10Qui synthesis was carried out following recently published procedures. A slightly modified first step of the two-step synthesis, previously reported, was carried out in a round bottom flask with stir bar. To this, 1.6 g of 4,4′-biphenol, 12.5 g of 1,10-dibromodecane, 1.6 g of potassium hydroxide, and 25 mL of ethanol (200 proof). The flask was then refluxed overnight under argon. The reaction was cooled to room temperature, where the resultant light blue solid was filtered with excess hot ethanol and water solution to obtain the intermediate BCPH10Br. The solid was dried overnight under vacuum. Next, 0.5 g of BCPH10Br, 0.35 g of quinuclidine, and 25 mL of dry acetonitrile was added to a round bottom flask and refluxed overnight under argon. Once cooled, 10 mL of diethyl ether was added to the reaction to precipitate the product BCPH10Qui. The solid was washed with excess diethyl ether to remove any unreacted starting materials and dried overnight under vacuum.

Synthesis of quasi-1D zeolite nanotubes. The synthesis of the quasi-1D hierarchical zeolite nanotubes (ZN) was carried out following recently published procedures. 0.113 g of the above synthesized SDA BCPh10Qui was added to 4.45 g of deionized water in a small (30 mL) poly(propylene) bottle with cap and stirred. Once homogenized, 0.067 g of sodium hydroxide was added. After the base dissolved, 0.027 g of alumina sulfate hydrate (Al₂(SO₄)₃·14-18H₂O) was added followed by the dropwise addition of 0.5 g of Ludox HS-30 colloidal silica. This gives a gel composition of 1.875 SiO₂:0.03 Al₂O₃:0.63 Na₂O:205H₂O. The gel was aged at room temperature while being vigorously stirred for 3 h in the poly(propylene) bottle. Next, a static hydrothermal reaction was carried out in a Teflon-lined autoclave at 423 K for 7 days. The resulting solid was washed through centrifugation with deionized water 3 times then dried in an over at 348 K. Calcination of this white solid was carried out under the following conditions: ramp to 823 K at 2 K/min, hold at 823 K for 6 days.

Additional description of the preparation of zeolite nanotubes is provided in WO 2022/031951, which is incorporated by reference herein in its entirety.

Preparation of poly(ethylenimine)/support composites. All sorbent composites were carried out utilizing a previously published procedure. Supports tested (MCM-41LP, MCM-41SP, SBA-15, and ZN) were all impregnated with poly(ethylenimine) (PEI) using the same method. PEI-800 was chosen as the amine due to its well documented high performance in CO₂ capture studies when compared against other easily accessible commercial amines. Sorbents were made through solvent impregnation of the amine into the porous materials. To compare uptake kinetics, a range of pore fillings was created for each substrate which was calculated based on weight percent of amine in the final substrate. First, 100 mg of the desired substrate was added to a round bottom flask with stir bar and charged with argon. To this round bottom flask, 10 mL of methanol was added. In a separate vessel, the appropriate amount of 800 M_{w} branched poly(ethylenimine) (PEI) was dissolved in methanol in a ratio of 100 mg:10 mL. Both these solutions were sonicated for one hour to insure homogeneity. The poly(ethylenimine) solution was then added into the round bottom flask containing the dispersed support and stirred overnight. Next, the solvent was removed using rotor evaporation (50° C.) to yield the resulting sorbent. The sorbent was dried under reduced pressure (10 mTorr) at 60° C. for 12 h. Sorbents were tested for desired properties with N₂ sorption and thermogravimetric analysis prior to use in experiments.

### Example 2

Herein, the exemplary study explored the use of a newly reported quasi-1D hierarchical zeolite nanotube as a support for CO₂ capture. The zeolites nanotubes (ZN) were compared with other common substrates for CO₂ Capture: SBA-15, MCM-41 with large pore (MCM-41-5.8), and MCM-41 with small pore (MCM-41-2.9). All compounds were wet impregnated with bPEI (800 M_{w}) in differing weight loadings until a decrease in efficiency was seen, normally at 100% pore filling as determined via N₂ sorption data.

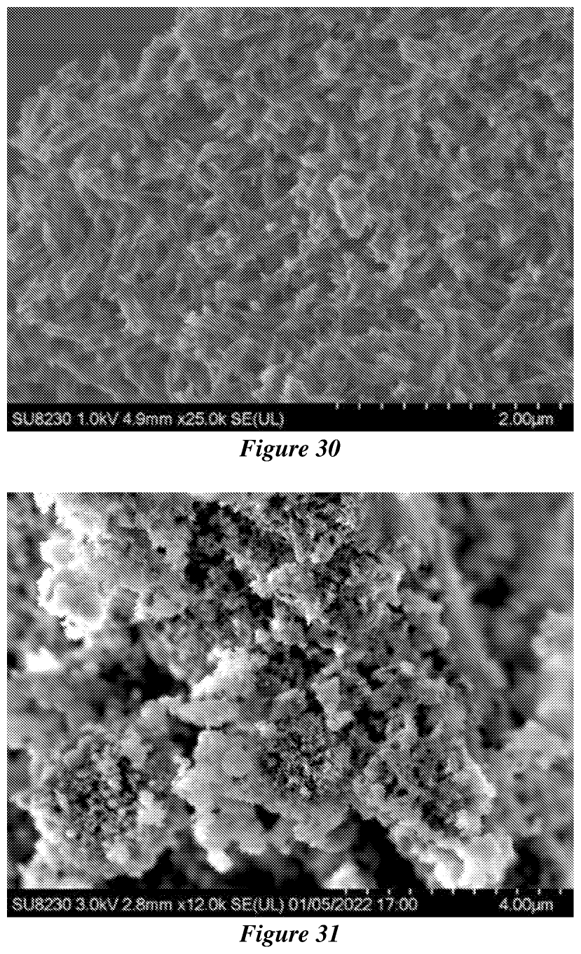

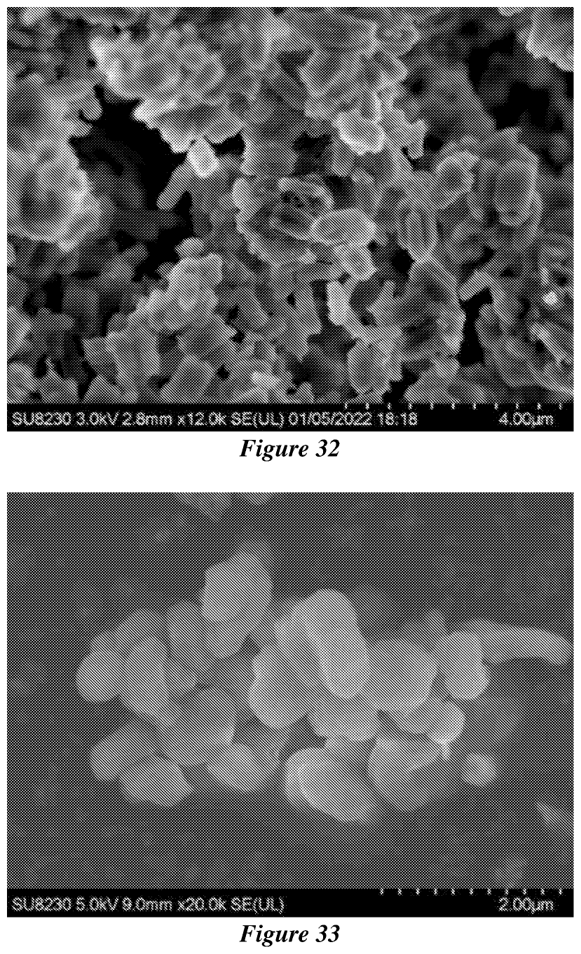

SEM was taken of all four supports after coating with gold, except the zeolite nanotube which remained bare. As can be seen in FIG. 30-FIG. 33, the morphology of each particle is slightly different. FIG. 31 shows the large pore MCM-41 and is a conglomerate of particles. This is most likely due to the addition of decane it its synthesis to increase the pore size. While the pore size desired was obtained, uniform morphology was sacrificed. FIG. 32 is the SEM of SBA-15 and shows larger pill shape particles that is indicative of the substrate. With particles roughly 0.8 μm in length, they are similar in length to some of the MCM-41-2.9 but much more uniform. FIG. 33 is non-uniform spherical/tubular particles with size ranging from 0.2 to 0.8 μm. The most interesting is the zeolite nanotube particle shape (FIG. 30). As the nanotubes tend to form together and stack as seen in their TEM, the SEM shows bundles of nanotubes. These bundles have lengths around 0.4 μm and widths around 0.05-0.1 μm. Due to their smaller size and narrow width, it is possible that CO₂ diffuses through the particles more efficiently to give faster uptake rates. The zeolite nanotubes have porous walls allowing faster diffusion of CO₂.

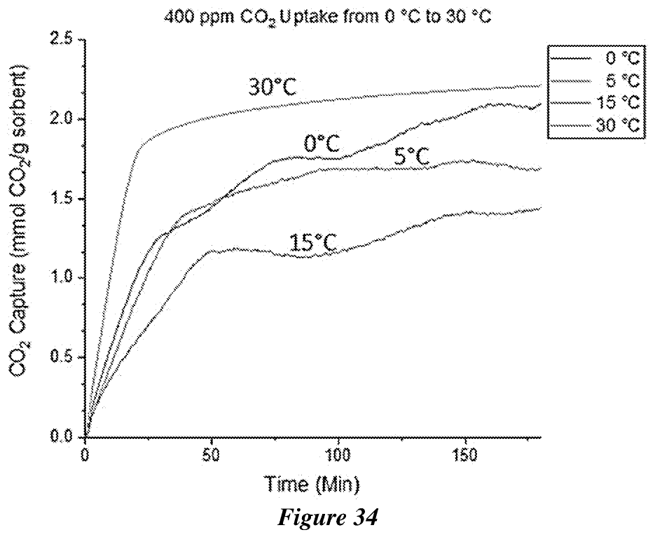

Working temperature is important for a CO₂ capture sorbent and ZN-65% PEI was tested over a range of temperature from 0° C. to 30° C. with 400 ppm CO₂ to determine how temperature effects its uptake efficiency. Initial testing shows that at low temperatures there is a decrease in CO₂ capture efficiency. These initial tests indicate that ZN-65% PEI works better at low temperature then at intermediate temperature as seen in FIG. 34.

The examples of the methods, devices, and compositions described herein directed to the single-walled zeolite nanotube is the first as a support for amines towards the use of CO₂ capture. Zeolites have previously been used to form CO₂ capture sorbents, these have either been 3D, bulk zeolites, or 2D, lamellar zeolites but not quasi-1D zeolite nanotubes. The examples, devices, and compositions can employ zeolite nanotube as a support for poly(ethylenimine). The resulting sorbent has been compared against well-studied substrates like SBA-15 and MCM-41. In both cases, the zeolite nanotubes show higher CO₂ capture and a higher initial capture rate. When tested in 400 ppm CO₂ and 10% CO₂, the zeolite nanotube shows identical uptake. The rate of uptake is an order of magnitude faster in zeolite nanotube at 10% CO₂ compared to at 400 ppm, they show approximately the same uptake capacity. Over multiple temperature swing cycles, zeolite nanotube does not decrease in efficiency in either concentration of CO₂.

### Example 3

Increasing levels of CO₂ necessitate improved methods of capturing this greenhouse gas to limit rising global temperatures. One promising way to lower levels is through capture and storage of CO₂. Prior research has demonstrated that aminopolymers rich in primary and secondary amines supported on mesoporous substrates are effective, selective sorbent materials. Common substrates used include mesoporous alumina and silica (such as SBA-15 and MCM-41). Conventional microporous materials are generally less effective, since the pores are too small to support non-volatile amines. Herein, newly discovered zeolite nanotubes, there first-of-their-kind quasi-1D hierarchical zeolite, are deployed as a substrate for various amines for CO₂ capture from dilute feeds. Poly(ethylenimine) (PEI) was impregnated into the zeolite at specific organic loadings. Thermogravimetric analysis (TGA) and porosity measurements were obtained to determine organic loading, pore filling, and surface area of the supported PEI prior to CO₂ capture studies. MCM-41 with comparable pore size and surface area was also impregnated with PEI to provide a benchmark material that allow for insight into the role of the zeolite nanotube intrawall micropores on CO₂ uptake rates and capacities. Over a range of PEI loadings, from 20 w/w %-80 w/w %, shows the zeolite allows for an increased CO₂ capture capacity over the mesoporous silica. This new zeolite can offer a platform for engineering additional reaction and separation processes.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The compositions and methods of the appended claims are not limited in scope by the specific compositions methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. An impregnated nanostructured hierarchical zeolitic material comprising a plurality of zeolite nanotubes, wherein each zeolite nanotube comprises a zeolitic wall perforated by a plurality of pores, the zeolitic wall defining a single longitudinal lumen, and wherein at least a portion of the plurality of zeolite nanotubes are impregnated with an amine.

2. The material of claim 1, wherein the amine comprises a primary amine, a secondary amine, a tertiary amine, or a combination thereof.

3. The material of claim 1, wherein the amine comprises monoethanolamine (MEA), diethanolamine (DEA), an amino acid, or a combination thereof.

4. The material of claim 1, wherein the amine comprises aliphatic-aryl amine of Formula I: 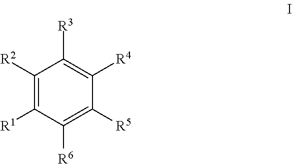
wherein
R¹, R², R³, R⁴, R₅, and R⁶ are each independently H or a substituted or unsubstituted C₁-C₂₀ aliphatic amine.

5. The material of claim 4, wherein R¹-R⁶ are each a substituted or unsubstituted C₁-C₂₀ aliphatic amine.

6. The material of claim 4, wherein R², R⁴, and R⁶ are each hydrogen and R¹, R³, and R⁵ are each a substituted or unsubstituted C₁-C₂₀ aliphatic amine.

7. The material of claim 1, wherein the amine is sterically hindered.

8. The material of claim 1, wherein the amine comprises an aminopolymer.

9. The material of claim 1, wherein the amine comprises poly(allylamine) (PAA), poly(glycidyl amine) (PGA), poly(propyleneimine) (PPI), poly(ethyleneimine) (PEI), derivatives thereof, or combinations thereof.

10. The material of claim 1, wherein the amine comprises poly(ethyleneimine).

11. The material of claim 1, wherein the material comprises the amine in an amount of from greater than 0 to 120 w/w %.

12. The material of claim 1, wherein the material comprises the amine in an amount of from 20 w/w % to 80 w/w %.

13. The material of claim 1, wherein the zeolitic wall comprises a zeolitic material, the zeolitic material comprising an aluminosilicate material.

14. The material of claim 1, wherein the zeolitic wall comprises some structural elements of a beta zeolite structure, an MFI zeolite structure, or a combination thereof.

15. The material of claim 1, wherein:
the plurality of zeolite nanotubes have an average length of from 20 nanometers (nm) to 10 micrometers (μm, microns);
the plurality of zeolite nanotubes have an average outer diameter of from 1 nanometer to 10 nanometers;
the plurality of zeolite nanotubes have an average aspect ratio of from 2 to 10,000;
the plurality of zeolite nanotubes have an average inner diameter of 0.5 nm to 9 nm;
the plurality of zeolite nanotubes have an average wall thickness of from 0.5 nm to 5 nm;
the plurality of zeolite nanotubes have an average surface area of from 500 to 5000 meters squared per gram of the plurality of zeolite nanotubes (m²/g);
the plurality of pores have an average diameter of from 0.2 to 2 nm;
or a combination thereof.

16. A method of use of the material of claim 1, the method comprising using the material as an adsorbent, in a chemical separation, or a combination thereof.

17. A method of use of the material of claim 1, the method comprising using the material for CO₂ capture and/or storage, wherein: the material captures 1.8 mmol CO₂ per gram of material or more; the material captures CO₂ at a rate of 2 mmol CO₂ per gram of material per minute or more; or a combination thereof.

18. The method of claim 17, wherein the method comprises direct air capture.

19. A method of use of the material of claim 1, the method comprising contacting the material with a fluid stream to separate a component from the fluid stream, wherein the fluid stream is selected from the group consisting of air, natural gas, byproducts of a chemical reaction, and post-combustion flue gas.

20. The method of claim 19, wherein the component separated from the fluid stream comprises CO₂.
